(19) United States
(12) Patent Application Publication
(10) Pub. No.: US 2026/0257593 A1
(43) Pub. Date: Sep. 3, 2026

(54) CHILD VEHICLE SEAT SYSTEM

(71) Applicant: WONDERLAND SWITZERLAND AG, Steinhausen (CH)

(72) Inventors: ANDREW J. Taylor, Morgantown, PA (US); ANDREW J. HORST, Morgantown, PA (US); Nathaniel W. KEEBLER, Morgantown, PA (US); PATRICK J.G. BOWERS, Morgantown, PA (US); CURTIS M. HARTENSTINE, Morgantown, PA (US); Zachary C. HARTENSTINE, Morgantown, PA (US); Kyle S. Mason, Morgantown, PA (US)

(21) Appl. No.: 19/469,446

(22) PCT Filed: Mar. 29, 2024
(86) PCT No.: PCT/US2024/022208

§ 371 Date: Sep. 26, 2025

Related U.S. Application Data
(60) Provisional application No. 63/493,209, filed on Mar. 30, 2023.
(60) Provisional application No. 63/504,057, filed on May 24, 2023.
(60) Provisional application No. 63/509,465, filed on Jun. 21, 2023.
(60) Provisional application No. 63/520,247, filed on Aug. 17, 2023.
(60) Provisional application No. 63/582,425, filed on Sep. 13, 2023.
(60) Provisional application No. 63/590,589, filed on Oct. 16, 2023.
(60) Provisional application No. 63/607,890, filed on Dec. 8, 2023.
(60) Provisional application No. 63/613,033, filed on Dec. 20, 2023.
(60) Provisional application No. 63/621,729, filed on Jan. 17, 2024.

(51) Int. Cl. B60N 2/28

(52) U.S. Cl. CPC B60N 2/2806; B60N 2/2816; B60N 2/2821; B60N 2/2869; B60N 2/2851; B60N 2/2875

(57) ABSTRACT

A child restraint system positionable on a vehicle seat includes a support base and belt tensioner mounted to the support base. The belt tensioner is movable between an open position and a closed position to apply a tension to a vehicle belt associated with the vehicle seat. A child seat attached to the support base is rotatable relative to the support base. The belt tensioner prevents rotation of the child seat relative to the support base when the belt tensioner is in the open position.

### CROSS REFERENCE TO RELATED APPLICATIONS

This application claims the benefit of U.S. Application No. 63/493,209, filed on Mar. 30, 2023; U.S. Application No. 63/504,057, filed on May 24, 2023; U.S. Application No. 63/509,465, filed on Jun. 21, 2023; U.S. Application No. 63/520,247, filed on Aug. 17, 2023; U.S. Application No. 63/582,425, filed on Sep. 13, 2023; U.S. Application No. 63/590,589, filed on Oct. 16, 2023; U.S. Application No. 63/607,890, filed on Dec. 8, 2023; U.S. Application No. 63/613,033, filed on Dec. 20, 2023; and U.S. Application No. 63/621,729, filed on Jan. 17, 2024, which is incorporated herein by reference in its entirety.

### FIELD

Embodiments of the present disclosure relate to the art of child restraint systems for use in a vehicle, and more particularly to a support base of a child restraint system.

### BACKGROUND

A child restraint system is designed to protect a child from injury or death during a collision of a vehicle. Existing child restraint systems commonly include a base portion and a seat portion detachably installed on the base portion. When a child restraint system is secured on a vehicle by a lower anchor or a vehicle belt, the base portion must be adjusted to a proper reclined angle. In addition, depending on the type of seat that is being used, the seat may be positioned either in a forward-facing or a rearward-facing orientation.

### BRIEF DESCRIPTION

According to an embodiment, a child restraint system positionable on a vehicle seat includes a support base and belt tensioner mounted to the support base. The belt tensioner is movable between an open position and a closed position to apply a tension to a vehicle belt associated with the vehicle seat. A child seat attached to the support base is rotatable relative to the support base. The belt tensioner prevents rotation of the child seat relative to the support base when the belt tensioner is in the open position.

In addition to one or more of the features described above, or as an alternative, in further embodiments the child seat is rotatable relative to the support base between a rearward-facing configuration and a forward-facing configuration. The child seat is in the rearward-facing configuration when the belt tensioner is in the open position.

In addition to one or more of the features described above, or as an alternative, in further embodiments the belt tensioner is movable from the closed position to the open position only when the child seat is in the rearward-facing configuration.

In addition to one or more of the features described above, or as an alternative, in further embodiments the support base includes a base anchor member and the child seat includes a seat anchor member. The base anchor member is connectable to the seat anchor member when the child seat is in the forward-facing configuration.

In addition to one or more of the features described above, or as an alternative, in further embodiments the child seat includes a seat portion having a notch formed at a front edge of the seat portion. The belt tensioner is arranged within the notch when the belt tensioner is in the open position.

In addition to one or more of the features described above, or as an alternative, in further embodiments the support base includes a seat portion and a back portion. The belt tensioner is receivable within an opening formed in the back portion when in the closed position.

In addition to one or more of the features described above, or as an alternative, in further embodiments the belt tensioner has one or more tensioner ribs and the back portion of the support base has one or more back ribs. When the belt tensioner is in the closed position, the vehicle belt is pressed against the one or more tensioner ribs and the one or more back ribs.

In addition to one or more of the features described above, or as an alternative, in further embodiments an incline of the child seat is adjustable relative to the support base.

In addition to one or more of the features described above, or as an alternative, in further embodiments the support base includes a first base member and a second base member operably coupled to the first base member. The second base member is movable with the child seat relative to the first base member to adjust the incline of the child seat.

In addition to one or more of the features described above, or as an alternative, in further embodiments the belt tensioner is associated with the second base member.

In addition to one or more of the features described above, or as an alternative, in further embodiments the child seat further includes a cupholder rotatably mounted to the child seat.

In addition to one or more of the features described above, or as an alternative, in further embodiments the cupholder is rotatable to a plurality of predetermined positions.

In addition to one or more of the features described above, or as an alternative, in further embodiments a belt guide is mounted to the support base to define a belt path insert. The belt guide cooperates with the belt tensioner to define a vehicle belt path.

In addition to one or more of the features described above, or as an alternative, in further embodiments the cupholder and the child seat comprise interfitting features for temporarily maintaining the cupholder in a rotated position.

In addition to one or more of the features described above, or as an alternative, in further embodiments the cupholder includes a rotation limit stop.

In addition to one or more of the features described above, or as an alternative, in further embodiments the belt guide is removably mounted to the support base via a belt path insert.

In addition to one or more of the features described above, or as an alternative, in further embodiments the belt tensioner further includes a frame having a latch for engaging a connector on the support base and an actuator operably coupled to the latch.

In addition to one or more of the features described above, or as an alternative, in further embodiments the actuator is rounded.

According to an embodiment, a child restraint system positionable on a vehicle seat includes a support base, and a child seat connected to the support base. The child seat is rotatable about an axis relative to the support base between a first rotational configuration and a second rotational configuration. A spin lock is operable to selectively lock rotation of the child seat relative to the support base. At least one actuator is operably coupled to the spin lock. The at least one actuator is operable to transform the spin lock between a locked position and an unlocked position in response to application of a force away from the child seat.

In addition to one or more of the features described above, or as an alternative, in further embodiments the spin lock includes a plurality of lock pins and the support base includes a plurality of lock sections. The plurality of lock pins are engaged with the plurality of lock sections when the spin lock is in the locked position and the plurality of lock pins are disengaged from the plurality of lock sections when the spin lock is in the unlocked position.

In addition to one or more of the features described above, or as an alternative, in further embodiments the plurality of lock pins are operably coupled to one another by a connecting link.

In addition to one or more of the features described above, or as an alternative, in further embodiments the at least one actuator includes a plurality of actuators and each of the plurality of actuators is operably coupled to a corresponding lock pin of the plurality of lock pins.

In addition to one or more of the features described above, or as an alternative, in further embodiments each actuator is operable individually to disengage the plurality of lock pins from the plurality of lock sections.

In addition to one or more of the features described above, or as an alternative, in further embodiments the plurality of actuators are operable simultaneously to disengage the plurality of lock pins from the plurality of lock sections.

In addition to one or more of the features described above, or as an alternative, in further embodiments the support base further includes a first base member and a second base member operably coupled to the first base member. A bottom of the child seat is receivable within the second base member. The plurality of lock sections are formed in the second base member.

In addition to one or more of the features described above, or as an alternative, in further embodiments the second base member includes a hook and the bottom of the child seat further comprises a lip. The hook is engaged with the lip to define a path of rotation of the child seat.

In addition to one or more of the features described above, or as an alternative, in further embodiments the lip is formed by a ring attached to the child seat via at least one fastener.

In addition to one or more of the features described above, or as an alternative, in further embodiments the lip is formed by a ring pinned to the child seat.

In addition to one or more of the features described above, or as an alternative, in further embodiments the spin lock includes a plurality of lock members, each of the plurality of lock members including one of the plurality of lock pins. The plurality of lock members is operably coupled by a plurality of linking straps.

In addition to one or more of the features described above, or as an alternative, in further embodiments the child seat is rotatable 180 degrees between the first rotational configuration and the second rotational configuration.

In addition to one or more of the features described above, or as an alternative, in further embodiments the first rotational configuration is a forward-facing configuration and the second rotational configuration is a rearward-facing configuration.

In addition to one or more of the features described above, or as an alternative, in further embodiments the at least one actuator is positioned on the child seat to receive a rotational force from a user and the child seat is rotatable between the first rotational configuration and the second rotational configuration in response to application of the rotational force.

In addition to one or more of the features described above, or as an alternative, in further embodiments including a secondary lock operably coupled to the at least one actuator and movable relative to the support base. The at least one actuator is operable to transform the spin lock between the locked position and the unlocked position only when the secondary lock is disengaged from the support base.

According to an embodiment, a child restraint system positionable on a vehicle seat includes a support base including a base seat portion and a base back portion and a child seat connected to the support base. The child seat includes a seat back portion. The child seat with the seat back portion is movable along an incline path relative to the support base between a first position and a second position. The base back portion is movable with the child seat including the seat back portion along the incline path.

In addition to one or more of the features described above, or as an alternative, in further embodiments the child seat is rotatable relative to said support base at any position of said child seat along said incline path between said first position and said second position.

In addition to one or more of the features described above, or as an alternative, in further embodiments the child seat is rotatable relative to the support base at any position of the child seat along the incline path.

In addition to one or more of the features described above, or as an alternative, in further embodiments the child seat is rotatable relative to the support base. The child seat is movable along the incline path when the child seat is in both a first rotational configuration and a second rotational configuration.

In addition to one or more of the features described above, or as an alternative, in further embodiments the support base includes a base anchor member and the child seat includes a seat anchor member. The base anchor member is connectable to the seat anchor member when the child seat is in the first rotational configuration.

In addition to one or more of the features described above, or as an alternative, in further embodiments the base anchor member is connectable to the seat anchor member at any position of the child seat along the incline path.

In addition to one or more of the features described above, or as an alternative, in further embodiments including a recline lock mechanism for selectively locking movement of the child seat at a position along the incline path.

In addition to one or more of the features described above, or as an alternative, in further embodiments the support base includes a first base member and a second base member operably coupled to the first base member. The second base member forms the base back portion of the support base.

In addition to one or more of the features described above, or as an alternative, in further embodiments the recline lock mechanism includes at least one recline pin and the first base member includes a plurality of lock openings. The at least one recline pin is engaged with a lock opening of the plurality of lock openings when the recline lock mechanism is in a locked position and the at least one recline pin is disengaged from the lock opening of the plurality of lock openings when the recline lock mechanism is in an unlocked position.

In addition to one or more of the features described above, or as an alternative, in further embodiments at least one recline pin includes a plurality of recline pins. The plurality of recline pins are operably coupled to one another by a pivot link.

In addition to one or more of the features described above, or as an alternative, in further embodiments at least one actuator is operably coupled to the recline lock mechanism. The at least one actuator is operable to transform the recline lock mechanism between the locked position and the unlocked position.

According to an embodiment, a method of installing a vehicle belt of a vehicle seat about a child restraint system includes positioning the vehicle belt along a belt receiving path of a support base, moving a belt tensioner relative to the support base to apply a tension to the vehicle belt along the belt receiving path, and adjusting an incline of a back portion of the support base relative to the vehicle seat to increase the tension in the vehicle belt.

In addition to one or more of the features described above, or as an alternative, in further embodiments adjusting the incline includes moving a second base member of the support base along an incline path relative to a first base member of the support base. The second base member forms the back portion of the support base.

In addition to one or more of the features described above, or as an alternative, in further embodiments adjusting the incline includes unlocking a recline lock mechanism coupling the second base member to the first base member.

In addition to one or more of the features described above, or as an alternative, in further embodiments adjusting the incline includes increasing the incline of the back portion.

In addition to one or more of the features described above, or as an alternative, in further embodiments rotating a child seat relative to the support base after moving the belt tensioner relative to the support base to apply the tension to the vehicle belt.

According to an embodiment, a child restraint system positionable on a vehicle seat includes a support base and a child seat connected to the support base. The child seat is rotatable about an axis relative to the support base. A spin lock selectively locks rotation of the child seat relative to the support base. An indicator is associated with the spin lock. The indicator is movable in response to movement of the spin lock between and a locked position and an unlocked position in order to visibly indicate to a user when the spin lock is in the locked position and when the spin lock is in the unlocked position.

In addition to one or more of the features described above, or as an alternative, in further embodiments the indicator includes a first indicator section operable to visibly indicate when the spin lock is engaged and a second indicator section operable to visibly indicate when the spin lock is disengaged.

In addition to one or more of the features described above, or as an alternative, in further embodiments the indicator is separate from the spin lock.

In addition to one or more of the features described above, or as an alternative, in further embodiments the indicator is rotatably mounted to the support base.

In addition to one or more of the features described above, or as an alternative, in further embodiments including a biasing mechanism operably coupled to the indicator to bias the indicator toward a position associated with when the spin lock is disengaged.

In addition to one or more of the features described above, or as an alternative, in further embodiments the spin lock opposes a biasing force of the biasing mechanism when the spin lock is engaged.

In addition to one or more of the features described above, or as an alternative, in further embodiments the spin lock includes a plunger operably coupled to the spin lock. The plunger is the visual indicator visible at the support base to visually indicate that the spin lock is engaged.

In addition to one or more of the features described above, or as an alternative, in further embodiments the plunger is part of the spin lock.

In addition to one or more of the features described above, or as an alternative, in further embodiments the plunger is arranged within a window formed at the support base when the spin lock is engaged.

In addition to one or more of the features described above, or as an alternative, in further embodiments the plunger is remote from a window formed at the support base when the spin lock is disengaged.

In addition to one or more of the features described above, or as an alternative, in further embodiments the support base at the window is a second indicator.

In addition to one or more of the features described above, or as an alternative, in further embodiments the absence of the plunger within a window formed at the support base is a visual indicator that the spin lock is in the unlocked position.

According to an embodiment, a child restraint system includes a child seat having a seat portion and a back portion including at least one upright side member. The seat portion and the back portion define an interior for receiving an occupant. At least one seat bolster is arranged at the at least one upright side member. A width of the interior for receiving the occupant is reduced by the at least one seat bolster.

In addition to one or more of the features described above, or as an alternative, in further embodiments the at least one seat bolster is positioned within the interior, proximate to a hip of the occupant.

In addition to one or more of the features described above, or as an alternative, in further embodiments the at least one seat bolster is integrally formed with the seat portion.

In addition to one or more of the features described above, or as an alternative, in further embodiments the at least one seat bolster is formed from a different material than the seat portion.

In addition to one or more of the features described above, or as an alternative, in further embodiments the seat portion includes a first seat side member and a second seat side member and the at least one seat bolster extends upwardly from the seat portion and terminates at or below a top of at least one of the first seat side member and the second seat side member.

In addition to one or more of the features described above, or as an alternative, in further embodiments the at least one seat bolster tapers in thickness in the forward direction.

In addition to one or more of the features described above, or as an alternative, in further embodiments the at least one seat bolster is formed from a rigid material.

In addition to one or more of the features described above, or as an alternative, in further embodiments the at least one seat bolster is a structural component associated with the child seat.

According to an embodiment, a child seat includes a seat back and a headrest movably coupled to the seat back. The headrest includes an actuator, a first lock member, and a second lock member. The first lock member is engageable with the seat back to lock the headrest relative to the seat back. The first lock member is movable between a locked position and an unlocked position. The second lock member is configured to disengage the first lock member from the seat back. The second lock member is movable between a second member locked position and a second member unlocked position. A linking member operably couples the actuator and at least one of the first lock member and the second lock member. When the second lock member is in the second member unlocked position, the first lock member is in the unlocked position, and when the second lock member is in the second member locked position, the first lock member is in the unlocked position.

In addition to one or more of the features described above, or as an alternative, in further embodiments when the linking member is actuated, the first lock member transforms to the unlocked position and the second lock member transforms to the second member unlocked position, wherein the first lock member and the second lock member transform simultaneously.

In addition to one or more of the features described above, or as an alternative, in further embodiments the second lock member and the linking member are formed as a single unitary part.

In addition to one or more of the features described above, or as an alternative, in further embodiments the first lock member is translatable relative to the second lock member between the locked position and the unlocked position.

In addition to one or more of the features described above, or as an alternative, in further embodiments the first lock member is rotatable relative to the second lock member between the locked position and the unlocked position.

According to an embodiment, a rotatable child restraint system includes a support base having a plurality of lock openings and a child seat rotatable relative to the support base. A spin lock is configured to selectively lock the child seat and the support base against rotation. The spin lock includes at least one boss engageable with a lock opening of the plurality of lock openings, at least one lock pin extending between the at least one boss toward a rotational axis of the child seat and at least one actuator configured to selectively release the at least one boss from the lock opening of the plurality of lock openings. The at least one boss is rigidly coupled to the at least one actuator.

In addition to one or more of the features described above, or as an alternative, in further embodiments the at least one boss includes two bosses, the at least one actuator includes two actuators, and the at least one lock pin includes two lock pins, each boss being operably coupled to a respective actuator via a respective lock pin.

In addition to one or more of the features described above, or as an alternative, in further embodiments the spin lock includes a connecting member pivotably coupled to the support base and the two lock pins are connected to the connecting member such that both bosses are retracted from a respective lock opening of the plurality of lock openings via rotation of the connecting member.

In addition to one or more of the features described above, or as an alternative, in further embodiments the at least one actuator and the at least one boss are movable in the same direction to release the at least one boss from the lock opening of the plurality of lock openings.

### BRIEF DESCRIPTION OF THE DRAWINGS

The following descriptions should not be considered limiting in any way. With reference to the accompanying drawings, like elements are numbered alike:

FIG. 1 is a perspective view of a child restraint system according to an embodiment;

FIG. 2 is a side view of the child restraint system of FIG. 1 in a forward-facing configuration according to an embodiment;

FIG. 3 is a side view of the child restraint system of FIG. 1 in a rearward-facing configuration according to an embodiment;

FIG. 4A is a perspective view of a portion of a headrest mechanism according to an embodiment;

FIG. 4B is another perspective view of a portion of a headrest mechanism according to an embodiment;

FIG. 5 is an exploded perspective of the child restraint system of FIG. 1 according to an embodiment;

FIG. 6A is a side perspective view of a child seat of the child restraint system according to an embodiment;

FIG. 6B is a bottom perspective view of a child seat of the child restraint system according to an embodiment;

FIG. 7 is a perspective view of a second base member of a support base according to an embodiment;

FIG. 8A is a perspective view of a portion of a second base member of a support base including a belt tensioner according to an embodiment;

FIG. 8B is a detailed perspective cross-sectional view taken through the belt tensioner of FIG. 8A according to an embodiment;

FIG. 9 is a perspective view of a spin lock of a child seat of the child restraint system according to an embodiment;

FIG. 10A is a plan view of the spin lock of FIG. 9 in a locked position according to an embodiment;

FIG. 10B is a plan view of the spin lock of FIG. 9 in an unlocked position according to an embodiment;

FIG. 11 is a perspective view of another spin lock of a child seat of the child restraint system according to an embodiment;

FIG. 12A is a plan view of the spin lock of FIG. 11 in a locked position according to an embodiment;

FIG. 12B is a plan view of the spin lock of FIG. 11 in an unlocked position according to an embodiment;

FIG. 13 is a perspective view of a spin lock of a child seat of the child restraint system according to an embodiment;

FIG. 14A is a plan view of the spin lock of FIG. 13 in a locked position according to an embodiment;

FIG. 14B is a plan view of the spin lock of FIG. 13 in an unlocked position according to an embodiment;

FIG. 15 is a perspective view of a spin lock of a child seat of the child restraint system including a visual indicator according to an embodiment;

FIG. 16A is a perspective view of the spin lock of FIG. 15 including a visual indicator when the spin lock is in the locked position according to an embodiment;

FIG. 16B is a perspective view of the spin lock of FIG. 15 including a visual indicator when the spin lock is in the unlocked position according to an embodiment;

FIG. 17A includes various views of a visual indicator of a child seat when the spin lock is in the locked position according to an embodiment;

FIG. 17B includes various views of a visual indicator of a child seat when the spin lock is in the unlocked position according to an embodiment;

FIG. 18A is a side view of a child restraint system having a child seat in a forward-facing, inclined position according to an embodiment;

FIG. 18B is a side view of a child restraint system having a child seat in a forward-facing, reclined position according to an embodiment;

FIG. 19 is a perspective partial-cross-sectional view of a support base including a recline lock mechanism according to an embodiment;

FIG. 20 is a perspective view of a first base member of a support base according to an embodiment;

FIG. 21A is a plan view of the recline lock mechanism of FIG. 20 in a locked position according to an embodiment;

FIG. 21B is a plan view of the recline lock mechanism of FIG. 20 in an unlocked position according to an embodiment;

FIG. 22A is a perspective view of a child seat in a rearward-facing configuration and an open belt tensioner according to an embodiment;

FIG. 22B is another perspective view of a child seat in a rearward-facing configuration and an open belt tensioner according to an embodiment;

FIG. 23A is a perspective view of a second base member of a support base including a belt tensioner and a belt guide according to an embodiment;

FIG. 23B is an exploded perspective view of a belt guide according to an embodiment;

FIG. 24 is a plan view of a child seat according to an embodiment;

FIG. 25 is a rear perspective view of a seat back portion of a child seat according to an embodiment;

FIG. 26 is a top perspective view of a seat support surface of a child seat according to an embodiment;

FIG. 27A is a bottom view of a child seat including a flange according to an embodiment;

FIG. 27B is a bottom view of the child seat of FIG. 27A with the flange removed according to an embodiment;

FIG. 28 is a perspective view of a side of a child restraint system including an actuator having a secondary lock according to an embodiment;

FIG. 29A is a is a perspective view of a portion of a headrest mechanism according to an embodiment;

FIG. 29B is a cross-sectional view of the headrest mechanism of FIG. 29A according to an embodiment;

FIGS. 30A and 30B are side views of a child restraint system according to an embodiment, in a forward-facing position and respectively in upright and reclined positions;

FIGS. 31A-C are respective top perspective, bottom perspective, and side views of a portion of the child restraint system of FIG. 30A;

FIGS. 32A-B are respective bottom perspective and top views of a portion of a child restraint system according to an embodiment, with certain parts shown as transparent;

FIG. 33 is a partial top view of the child restraint system of FIG. 32A, with certain parts schematically shown;

FIGS. 34A-C are respective side perspective, front, and top views of a child restraint system according to an embodiment;

FIG. 35 is a side perspective view of a child restraint system according to an embodiment and interacting with a vehicle belt;

FIG. 36A is a top cross-sectional view of a portion of the child restraint system of FIG. 35, with certain parts schematically shown;

FIG. 36B is a partial zoomed view of FIG. 36A with the vehicle belt omitted;

FIG. 37A is a side view of a support base for a child restraint system according to an embodiment;

FIG. 37B is a partial zoomed view of the support base of FIG. 37A;

FIG. 37C is a bottom view of the portion of the support base shown in FIG. 37B;

FIGS. 38A-C are exploded views of the portion of the support base shown in FIG. 37B;

FIG. 39A is a perspective view of a child restraint system including an actuator mechanism associated with the headrest according to an embodiment;

FIG. 39B is a partially exploded perspective view of the child restraint system of FIG. 39A according to an embodiment;

FIG. 40A is a rear perspective view of the headrest of FIG. 39B according to an embodiment;

FIG. 40B is a rear perspective view of the headrest of FIG. 40A with a backing of the headrest removed according to an embodiment;

FIG. 41A is a cross-sectional view of a locking mechanism of an actuation mechanism of a headrest in a locked position according to an embodiment;

FIG. 41B is a cross-sectional view of the locking mechanism of FIG. 41A in an unlocked position according to an embodiment;

FIG. 42A is a cross-sectional view of a locking mechanism of an actuation mechanism of a headrest in a locked position according to an embodiment;

FIG. 42B is a cross-sectional view of the locking mechanism of FIG. 42A in an unlocked position according to an embodiment;

FIG. 43A is a cross-sectional view of a locking mechanism of an actuation mechanism of a headrest in a locked position according to an embodiment;

FIG. 43B is a cross-sectional view of the locking mechanism of FIG. 43A in an unlocked position according to an embodiment;

FIG. 44 is another cross-sectional view of a locking mechanism having a first locking member engaged with a slot arranged at a seat back of the child seat according to an embodiment;

FIG. 45A is a side view of a child restraint system having a child seat including at least one reinforcement member according to an embodiment;

FIG. 45B is a front view of the child restraint system of FIG. 45A according to an embodiment;

FIG. 45C is a front perspective view of the child restraint system of FIG. 45A according to an embodiment;

FIG. 46 is a rear view of a headrest of the child restraint system of FIG. 45A according to an embodiment;

FIG. 47A is a rear view of a support base of the child restraint system including a storage compartment according to an embodiment;

FIG. 47B is a rear view of the support base of FIG. 47A including a cover arranged over the storage compartment according to an embodiment;

FIG. 48 is a perspective view of a spin lock according to an embodiment;

FIG. 49A is a top perspective view of a child seat including the spin lock of FIG. 48 in a locked position according to an embodiment;

FIG. 49B is a top perspective view of a child seat including the spin lock of FIG. 48 in an unlocked position according to an embodiment;

FIG. 50A is a side perspective view of a child seat including the spin lock of FIG. 48 in a locked position according to an embodiment;

FIG. 50B is a top perspective view of a child seat including the spin lock of FIG. 48 in an unlocked position according to an embodiment; and

FIG. 51 is a top perspective view of a support base including at least one opening associated with a spin lock according to an embodiment.

### DETAILED DESCRIPTION

A detailed description of one or more embodiments of the disclosed apparatus and method are presented herein by way of exemplification and not limitation with reference to the Figures.

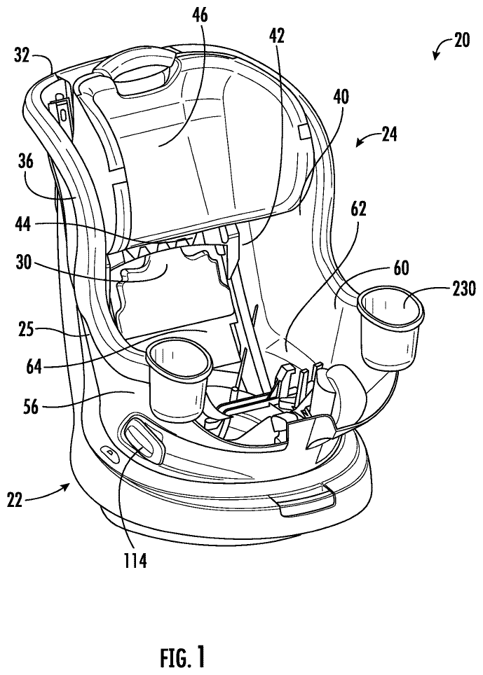

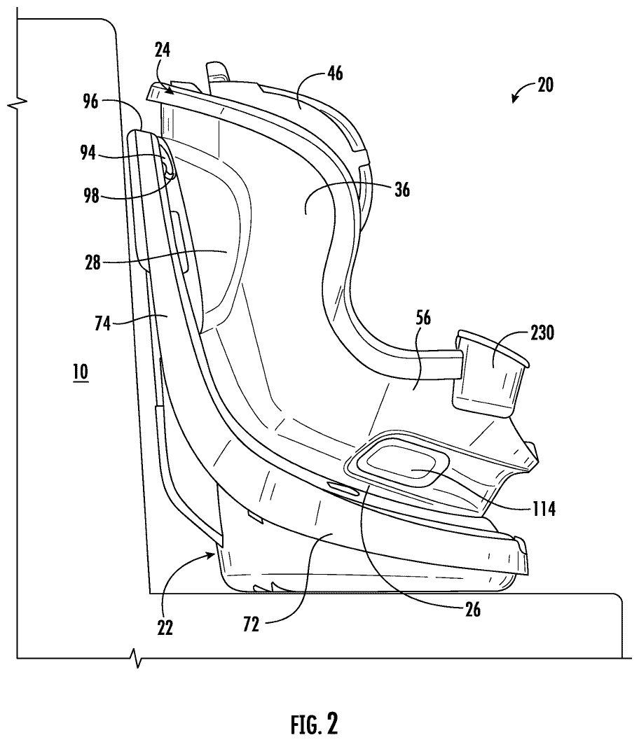

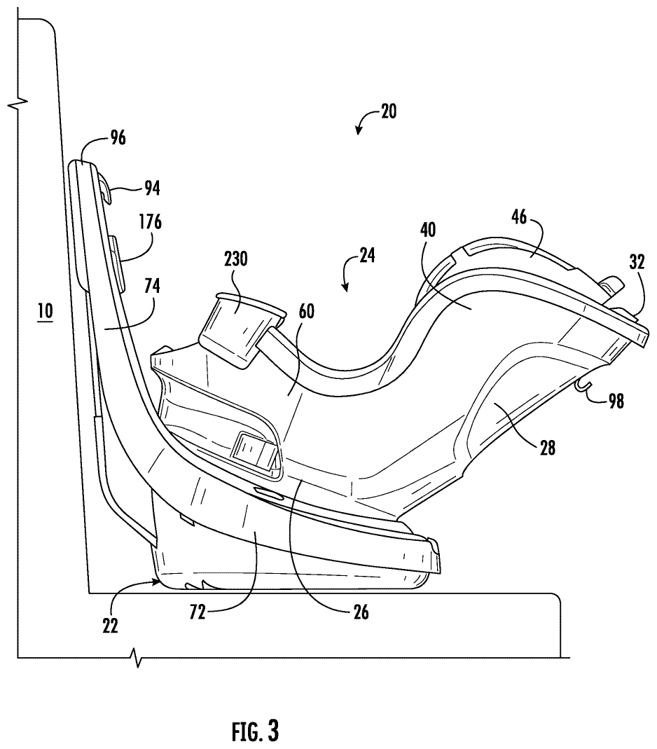

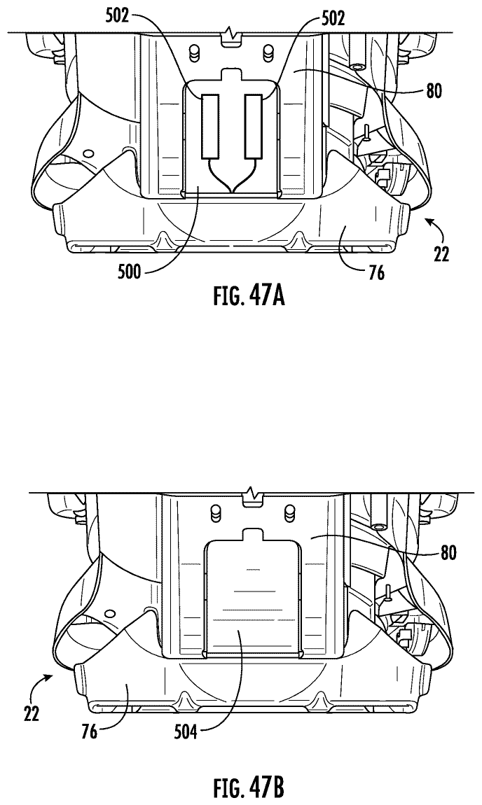

With reference now to the FIG. 1, an example of a child restraint system 20 is illustrated according to an embodiment. The child restraint system 20 includes a support base 22 that can be detachably fixed to a vehicle seat 10 (see FIGS. 2 and 3), such as via a latch or anchor mechanism 502 (see FIG. 47A). This latch or anchor system often used is sometimes referred to as a “lower anchor and tether for children” e.g., LATCH system. Alternatively, or in addition, as will be described in more detail below, the support base 22 may be detachably fixed to a vehicle seat 10 via a vehicle belt associated with the vehicle seat 10.

The child restraint system 20 additionally includes a rigid child seat 24 connected to the support base 22. In an embodiment, the child seat 24 is detachably coupled to the support base 22, thereby allowing the child seat 24 to be separated from the support base 22. Alternatively, the support base 22 and the child seat 24 may be permanently connected or affixed together. As used herein the term “permanently connected” represents embodiments where the child seat 24 is not intended to be disassembled from the support base 22 by a user.

The child seat 24 may include a seat shell 25 having a seat portion 26 and a seat back or upright portion 28 arranged at an angle relative to the seat portion 26. The seat portion 26 and the seat back portion 28 may be detachably coupled, or alternatively, may be permanently coupled. In the illustrated, non-limiting embodiment, the seat portion 26 and the seat back portion 28 are integrally formed as a single unitary body. In another alternative aspect, the seat back portion 28 can be rotationally connected to the seat portion 26 such that the seat back portion 28 can incline and recline relative to the seat portion 26.

As shown, the seat back portion 28 of the child seat 24 includes an upright support surface 30 generally facing forward and that extends from a first end or top 32 to a second, opposite end or bottom 34 of the upright portion. A first upright side member 36 may be arranged at a first side 38 of the upright support surface 30 and a second upright side member 40 may be arranged at a second, opposite side 42 of the upright support surface 30. The first and second upright side members 36, 40 therefore form the left side and the right side of the seat back portion 28, respectively. As shown, the first and second upright side members 36, 40 extend forward from the upright support surface 30. The first and second upright side members 36, 40 may extend generally orthogonally to the upright support surface 30 or alternatively, may extend therefrom at another angle, such as an angle greater than 90° for example. Accordingly, the upright support surface 30 and the first and second upright side members 36, 40 define a backrest region or upright support cavity 44 within which an upper body of a child is received.

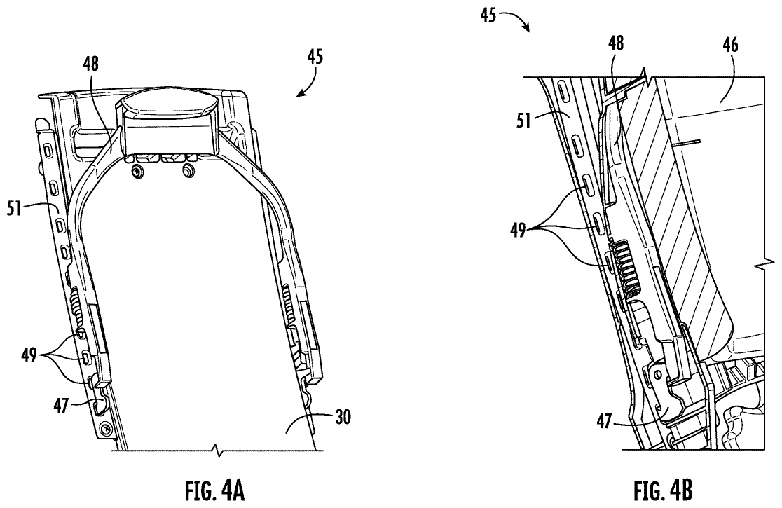

In the illustrated, non-limiting embodiment, the seat back portion 28 of the child seat 24 includes a headrest 46. The headrest 46 is attached to or integral with the seat back portion 28. The headrest 46 may be stationary or in some embodiments, may be configured to move relative to the upright support surface 30. For example, the headrest 46 may be configured to translate relative to the upright support surface 30 between a retracted position and an extended position, allowing for adjustment based on the size of the child positioned within the child seat 24. With reference to FIGS. 4A and 4B, a mechanism 45 for controlling movement of the headrest 46 is illustrated. As shown, a ratchet or tooth 47 extending from a bracket 48 connected to the headrest 46 is spring biased into engagement with one of a plurality of openings 49 formed in an adjacent channel 51 mounted to the seat shell 25. This engagement between the tooth 47 and a corresponding opening 49 restricts movement of the headrest 46 relative to the seat shell 25. A user can apply a force to the bracket 48 to oppose the bias of the tooth 47 and selectively disengage the tooth 47 from an opening 49, thereby allowing movement of the headrest between a plurality of positions.

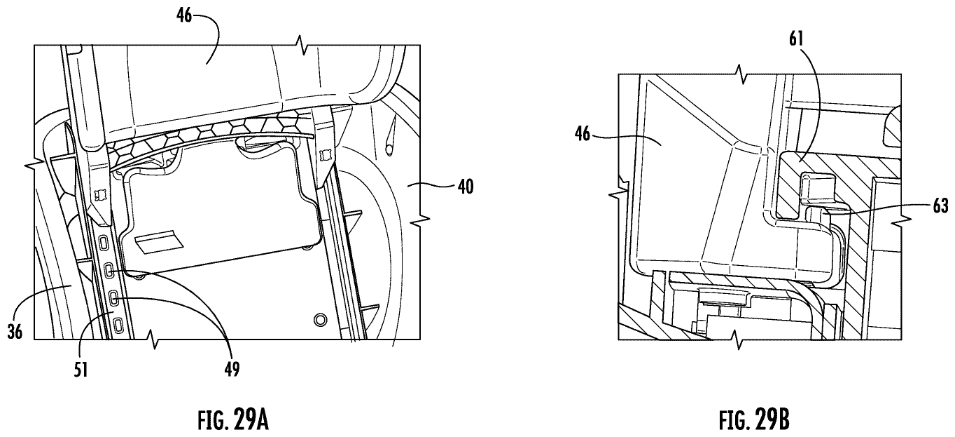

In another embodiment, shown in FIG. 29A-29B, the headrest 46 is again configured to engage one of a plurality of openings 49 formed in an adjacent channel 51, such as mounted to the seat shell 25. However, as shown, instead of a bracket 48, a track 61 is coupled to the headrest 46 and is movable therewith relative to the one or more channels 51. As shown, the headrest 46 itself may include a protrusion or hook tooth 63 that cooperates with a portion of the headrest track 61 to couple the headrest track 61 to the headrest 46. As shown, the headrest track 61 may be retrained between a surface of the headrest 46 and the hook tooth 63.

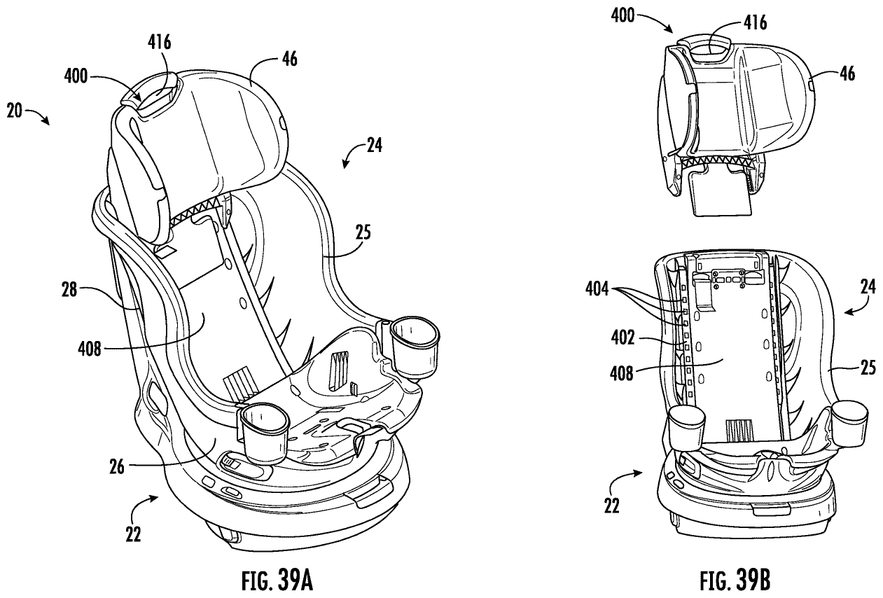

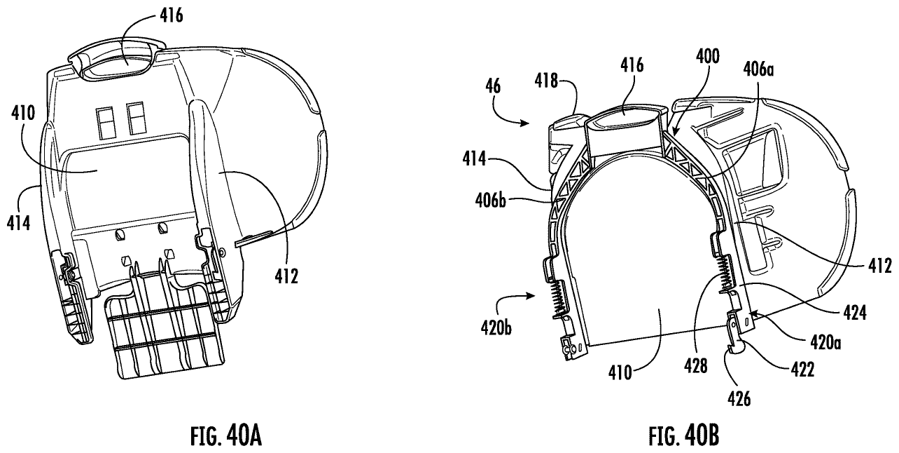

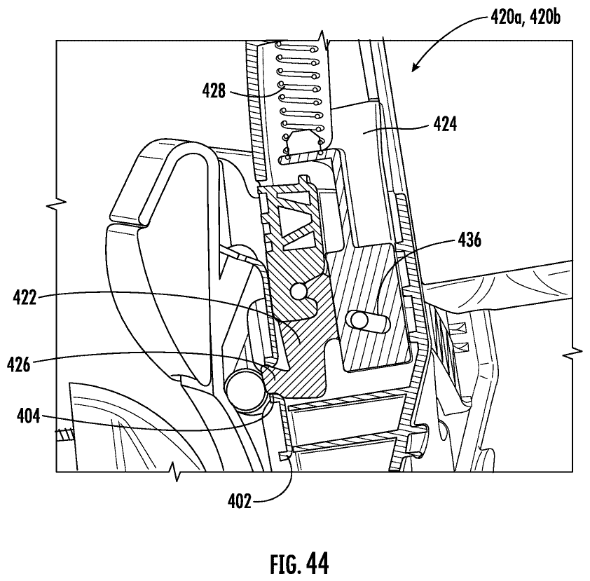

With reference now to FIG. 39A-44, an example of child restraint system 20 including an actuation mechanism 400 associated with movement of a headrest 46 relative to a child seat 24 is illustrated. The actuation mechanism 400 may include at least one linking member 406a, 406b (FIGS. 40A and 40B) arranged in alignment with a plurality of openings or slots 404 arranged at a seat back 408 of the seat shell 25. In an embodiment, the openings or slots 404 are formed in a channel 402 (see FIG. 39B) located at the seat shell 25 of the child seat 24. As shown, the actuation mechanism 400 includes a first linking member 406a positionable near a first side 412 of a back portion 410 of the headrest 46 and a second linking member 406b arranged near a second, opposite side 414 of the back portion 410 of the headrest 46. However, embodiments including only a single linking member, or alternatively, more than two linking members are within the scope of the disclosure.

The actuation mechanism 400 additionally includes an actuator 416, such as a handle for example, arranged at an exterior of the headrest 46 for access by a user. In the illustrated, non-limiting embodiment, the actuator 416 is disposed at or proximate a top 418 of the headrest 46. The actuator 416 may be accessible at a front of the headrest (FIG. 39B) or via the back of the headrest 46 (see FIG. 46). The at least one linking member 406a, 406b is operably coupled to the at least one actuator 416. As shown, a first end of each of the plurality of linking members 406a, 406b is connected to, or in some embodiments integrally formed with, the actuator.

A respective locking mechanism 420a, 420b may be associated with each linking member 406a, 406b to selectively engage one or more of the plurality of openings 404 of an adjacent channel 402. Accordingly, in the illustrated, non-limiting embodiment, a first locking mechanism 420a is operably connected to the first linking member 406a and a second locking mechanism 420b may be operably connected to the second linking member 406b.

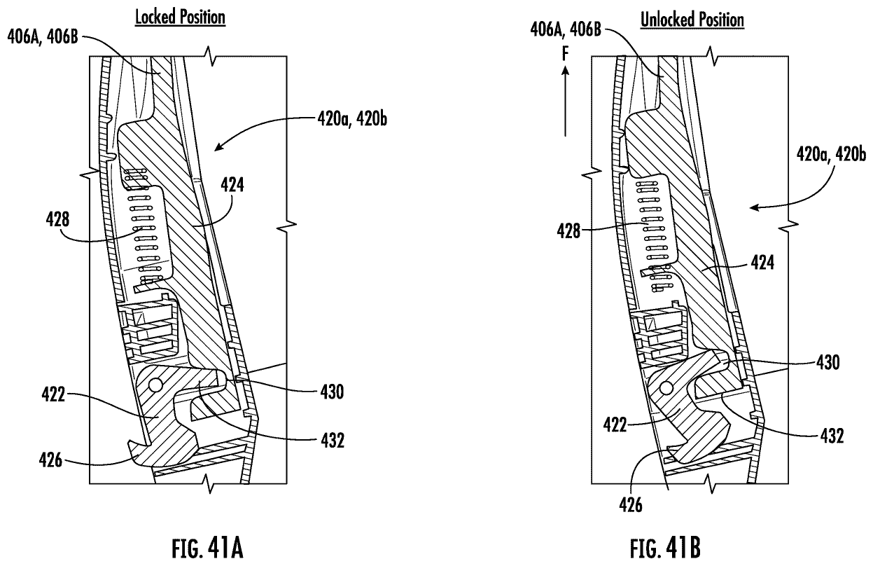

An example of a respective locking mechanism 420a, 420b is illustrated in FIGS. 41A-43B. As shown, each locking mechanism 420a, 420b may include a first lock member 422 operably coupled to a second lock member 424. In the illustrated, non-limiting embodiment, the second lock member 424 may be arranged at or integrally formed with a distal end of a linking member 406a, 406b. The first lock member 422 is movably coupled to the second lock member 424 and includes a feature 426 configured to engage a corresponding opening 404 of the channel 402. A biasing mechanism 428, such as a spring for example, may be configured to bias the first lock member 422 into engagement with one of a plurality of openings or slots 404 formed in an adjacent channel 402 mounted to the seat shell 25. This engagement between the first lock member 422 and a corresponding slot 404 restricts movement of the headrest 46 relative to the seat shell 25.

The first lock member 422 is disengageable from a respective opening 404 in response to application of a force F to the handle 416. Once disengaged, the headrest 46 is movable relative to the child seat 24. When the user actuates the handle 416 of the headrest 46, a force F is applied to the at least one linking member 406 operably coupled thereto, causing the at least one linking member 406 to transform from a locked position to an unlocked position. This movement of the at least one linking member 406a, 406b relative to the headrest 46 to the unlocked position opposes the biasing force of the biasing mechanism 428.

In an embodiment, movement of the second lock member 424 to the unlocked position, such as via application of a force to the actuator 416 for example, will simultaneously transition the first lock member 422 from a locked position (41A, 42A, 43A) to an unlocked position (41B, 42B, 43B). Accordingly, the connection between the first and second lock members 422, 424 results in the first lock member 422 being in the same configuration (locked or unlocked) as the second lock member 424. For example, when the first lock member 422 is in the locked configuration, the second lock member 424 is also in the locked configuration and when the first lock member 422 is in the unlocked configuration, the second lock member 424 is also in the unlocked configuration.

An example of an interface between the first lock member 422 and the second lock member 424 is shown in FIGS. 41A-41B. In the illustrated, non-limiting embodiment, the second lock member 424 has a groove or recess 430 formed therein, such as at a location near an end 432 of the second lock member 424 for example. The first lock member 422 may include a locking feature 434, such as a protrusion for example. The first lock member 422 may be pivotally mounted to the structure of the headrest 46 such that the locking feature 434 is arranged within the recess 430 formed in the second locking member 424. As the second lock member 424 moves vertically upward in response to application of a force to the actuator 416, the engagement between the locking feature 434 and the recess 430 will cause the first lock member 422 to pivot about its axis, out of engagement with a slot 404. Similarly, when the actuator 416 is released, the biasing force of the biasing mechanism 428 will apply a downward force to the second lock member 424, and the engagement between the locking feature 434 and the recess 430 will cause the first lock member 422 to pivot about its axis into engagement with an adjacent slot 404.

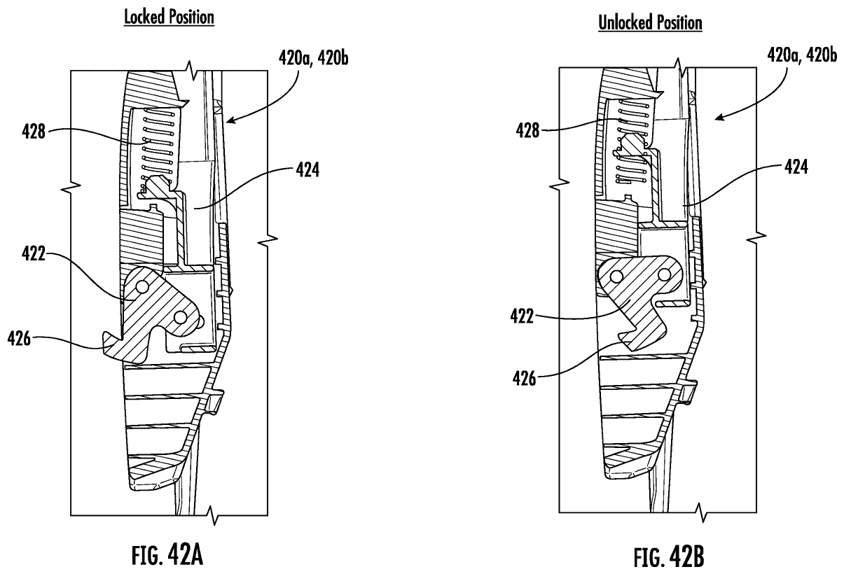

However, in other embodiments, such as shown in FIGS. 42A-42B, the first lock member 424 may be pivotally mounted to the structure of the headrest 46 and is pivotally coupled directly to the second lock member 424. In such embodiments, the movement of the second lock member 424 in an upward direction toward an unlocked position will cause the first lock member 422 to pivot about both axes out of engagement with a slot 404. Further, movement of the second lock member 424 downwardly driven by the biasing mechanism 428 toward a locked position, will cause the first lock member 422 to pivot about both axes into engagement with an adjacent slot 404.

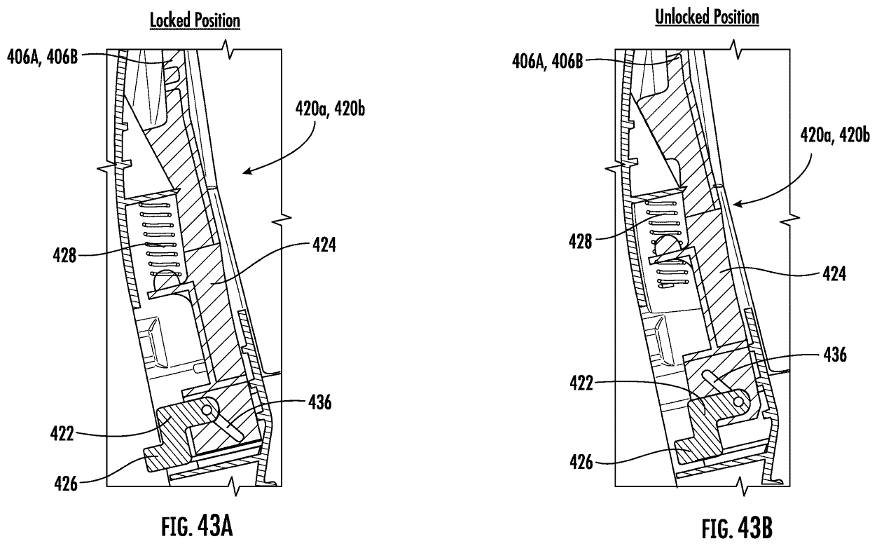

Yet another example of a locking mechanism, such as locking mechanism 420a or 420b for example, is illustrated in FIGS. 43A-43B. As shown, the second lock member 424 may have a slot 436 formed therein and the first lock member 422 is slidably coupled to the second lock member 424 via the slot 436. When the second lock member 424 is moved upwardly, the first lock member 422 is configured to translate relative to the second lock member 424 via the slot 436. Because the slot 436 is arranged at an oblique angle relative to the seat back 408, the first lock member 422 translates out of engagement with a slot 404 as the second lock member 424 moves upwardly. When the second lock member 424 is moved downward, such as in response to the biasing force of a biasing mechanism 428, the first lock member 422 translates laterally into engagement with a corresponding slot 404. It should be appreciated that the various embodiments of a locking mechanism 420a, 420b illustrated and described herein are intended as an example only and that a locking mechanism having another configuration, such as where the first lock member 422 is configured to pivot and translate between a locked and unlocked position, is within the scope of the disclosure.

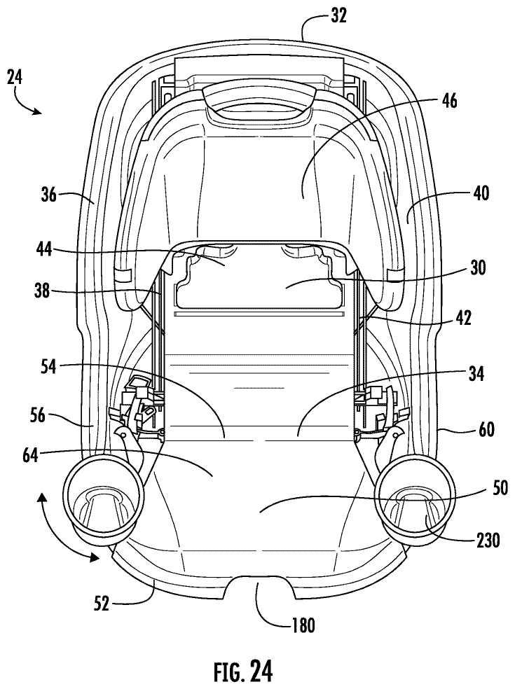

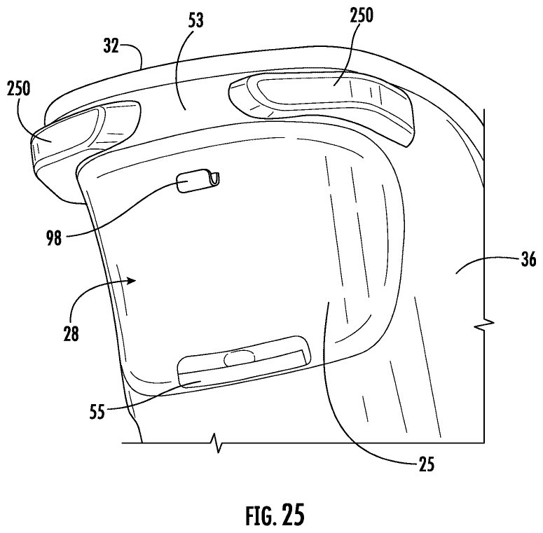

With reference to FIG. 24, one or more bumpers or side impact pods 250 designed to absorb forces in the event of an accident or crash, may be arranged at the exterior of the seat back portion 28 of the seat shell 25. Although the side impact pods are illustrated as being arranged near the top 32 of the seat back portion 28, it should be appreciated that they may be positioned at any suitable location. In the illustrated, non-limiting embodiment a first side impact pod 250 wraps from a back surface 53 of the seat back portion 28 to the exterior surface the first upright side member 36 and a second, substantially identical impact pod 250 wraps from the back surface 53 about an exterior surface of the second upright side member 40. However, it should be appreciated that embodiments where the impact pads 250 are positioned solely at the back surface 53 or the upright side members 36, 40 are also contemplated herein. With continued reference to FIG. 24, a pocket 55 may be formed in the seat shell 25, such as in the seat back portion 28 of the seat shell 25 for example. In the illustrated, non-limiting embodiment, the pocket 55 is formed in the back surface 53 and is sized to receive an instruction manual associated with the child restraint system 20.

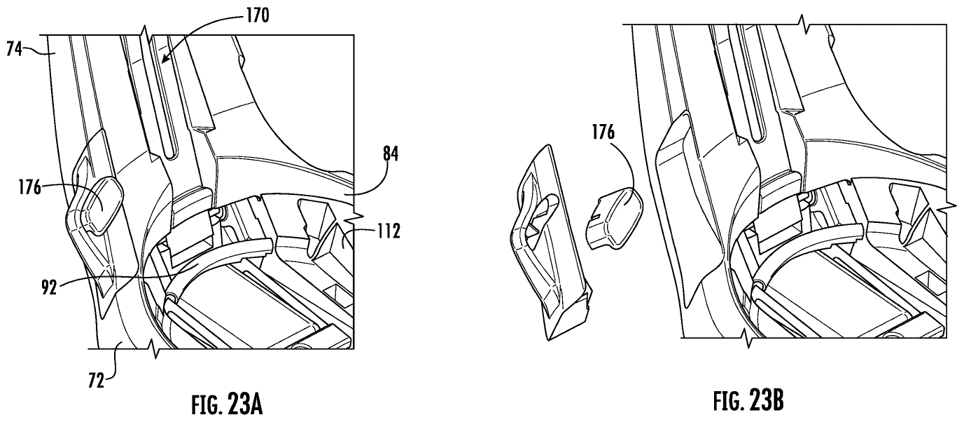

The seat portion 26, best shown in FIG. 23, includes a seat support surface 50 facing generally upwardly and that extends from a first end or front 52 to a second end or back 54 of the seat portion. A first seat side member 56 may be arranged at a first side 58 of the seat support surface 50 and a second seat side member 60 may be arranged at a second, opposite side 62 of the seat support surface 50. The first seat side member 56 and the second seat side member 60 extend upwardly and from the left side and the right side of the seat portion. The seat support surface 50 and the first and second seat side members 56, 60 in combination define a region 64 within which at least part of a lower body of a child may be received.

As shown, the first and second seat side members 56, 60 extend at an angle from the seat support surface 50. The angle of the first seat side member 56 relative to the seat support surface 50 may but need not be the same as the angle of the first upright side member 36 relative to the upright support surface 30. Similarly, the angle of the second seat side member 60 relative to the seat support surface 50 may but need not be the same as the angle of the second upright side member 40 relative to the upright support surface 30. In an embodiment, the first upright side member 36 and the first seat side member 56 are integrally formed and the second upright side member 40 and the second seat side member 60 are integrally formed.

Although generally not shown, the child seat 24 additionally includes a harness assembly for restraining a child within the child seat 24. Typical harness assemblies include two shoulder straps connectable to at least one crotch strap via a buckle. With reference to FIG. 26, in an embodiment, an opening 69 formed in the seat portion 26 of the child seat 24 and associated with the crotch strap of the harness assembly may have a general H-shape. By configuring the opening 69 in the manner, the crotch buckles can be easily adjusted between a front position and a back position relative to the seat support surface 50.

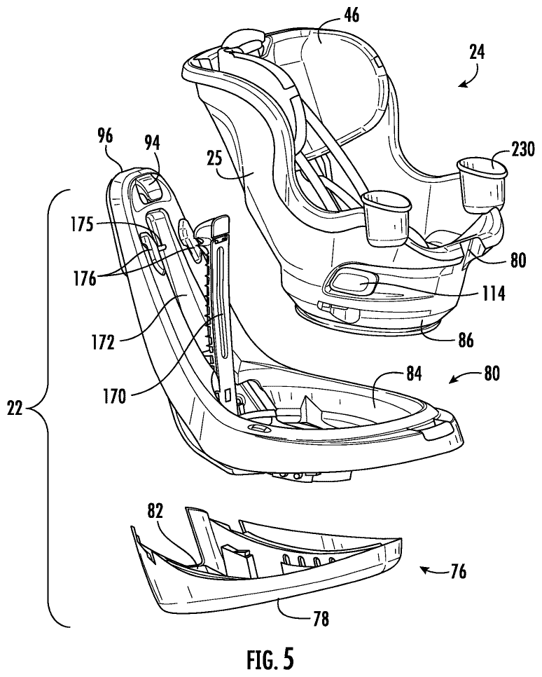

The support base 22 for mounting the child seat 24 includes base body having a base seat portion 72 and a base back portion 74. Suitable materials for making the base body include but are not limited to rigid plastic or composite materials for example. The base seat portion 72 and the base back portion 74 may be integrally formed as a unitary body, or alternatively, may be formed by separate components removably or permanently connected together. With reference to FIG. 5, in the illustrated, non-limiting embodiment, the support base 22 includes a first base member 76 having a bottom surface 78 suitable for placement on a support surface, such as a vehicle seat 10 for example, and a second base member 80 coupled to the first base member 76. In the illustrated, non-limiting embodiment, at least a portion of the second base member 80 is positioned in overlapping arrangement with an upper surface 82 of the first base member 76. In the embodiments shown in the FIGS., the base back portion 74 of the support base 22 is formed solely by the second base member 80, and the base seat portion 72 of the support base 22 is formed by the first base member 76 and the second base member 80, in combination.

With reference to FIGS. 47A-47B, a storage compartment 500 may be formed in a portion of the support base 22. Although the storage compartment 500 is illustrated as being formed solely in the second base member 80, embodiments where the storage compartment 500 is formed solely in the first base member 76, or alternatively, formed by the first and second base members 76, 80 in combination, are also within the scope of the disclosure. In an embodiment, one or more latches 502 for affixing the child seat system 20 to a vehicle seat, such as of a LATCH system for example, may be retained within the storage compartment 500. As shown, a cover 504 may be movable relative to the support base 22 between an open position (FIG. 47A) and a closed position (FIG. 47B) to selectively seal the storage compartment 500. In an embodiment, the cover 504 is removable from the support base 22. However, in other embodiments, the cover 504 may be movably coupled, for example pivotably or hingedly coupled, to the support base 22 such that the cover 504 remains affixed to the support base when the cover 504 is both the open and closed positions.

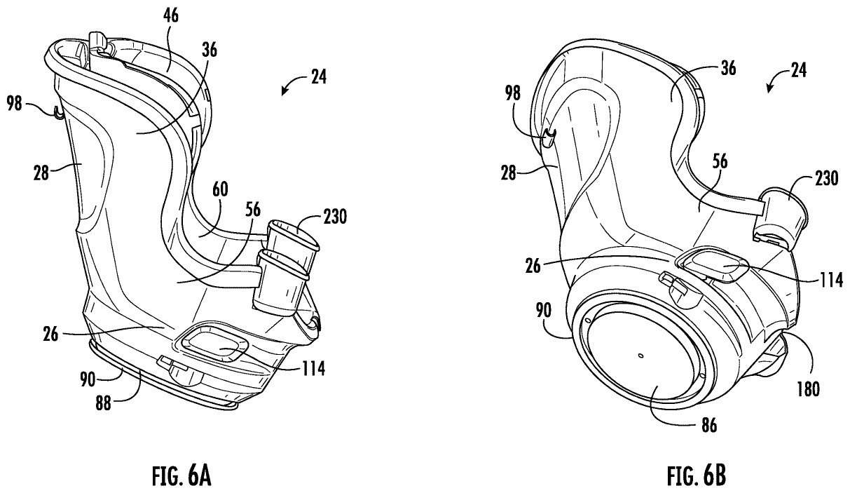

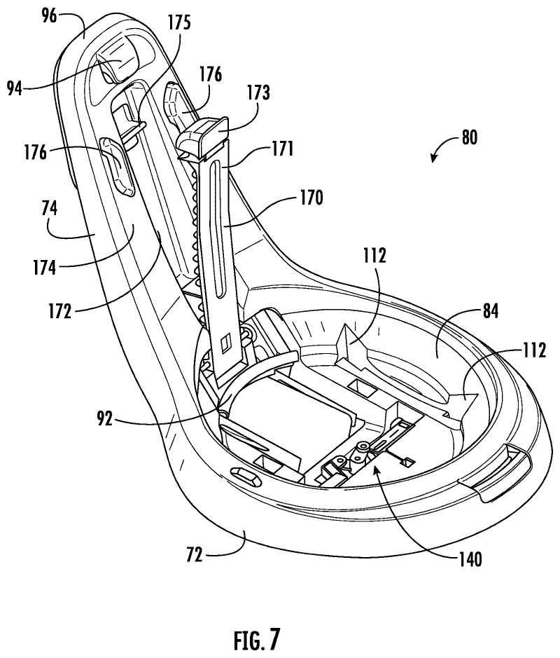

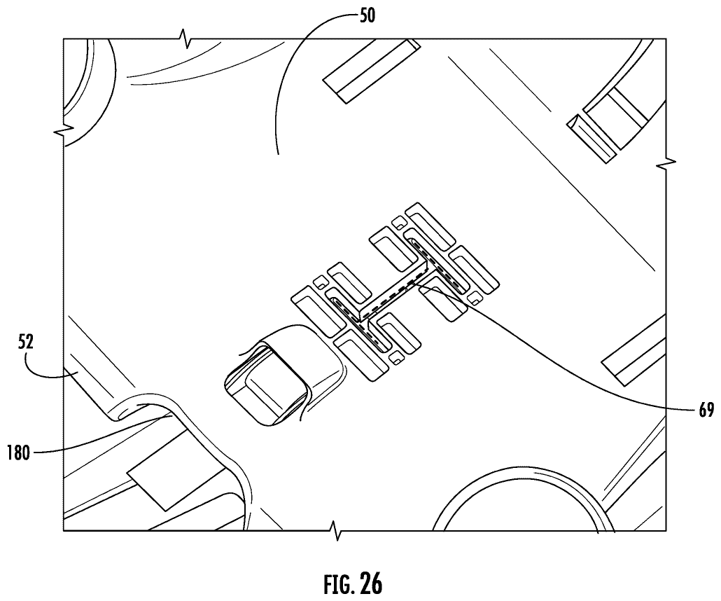

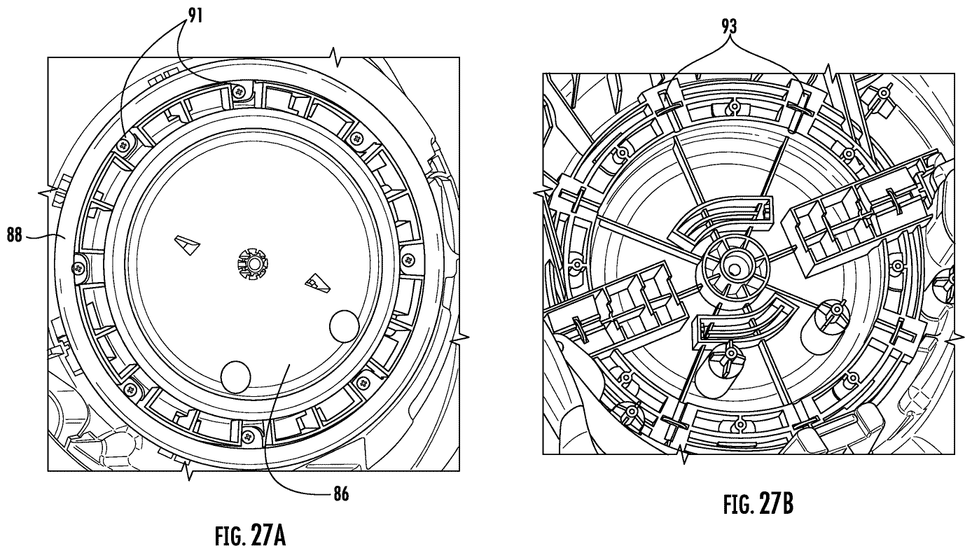

As shown, the child seat 24 may be affixed directly to the second base member 80. For example, the base seat portion 72 of the second base member 80 may include a contour or opening 84 (see FIG. 7) and a bottom end 86 of the child seat 24 is arranged within the opening 84. In an embodiment, shown in FIGS. 6A and 6B, the bottom end 86 of the child seat 24, arranged beneath the seat portion 26 of the child seat for example, includes a flange 88 having an edge rolled or otherwise shaped to form a lip or seat anchor 90. The second base member 80 may include one or more hooks or anchors 92 having a corresponding curvature configured to engage the lip 90. In an embodiment, best shown in FIG. 27A, the flange 88 that forms the lip 90 is a ring removably coupled to the bottom of the child seat 24 via at least one fastener, and in some embodiments, by a plurality of fasteners 91. Although eight screws are shown, it should be appreciated that any suitable fastener or coupler is within the scope of the disclosure. Further, any number of fasteners or couplers, including a single fastener, two fasteners, three fasteners, four fasteners, five fasteners, six fasteners, seven fasteners, or more than eight fasteners are contemplated herein. Alternatively, or in addition, one or more pins 93 (see FIG. 27B), embedded within the child seat 24 may be used to attach the flange 88 to the child seat 24.

The child seat 24 may be rotatable relative to the support base 22 between a plurality of configurations. In an embodiment, the child seat 24 is rotatable relative to both the first and second base members 76, 80 of the support base 22. For example, the engagement between the seat anchor 90 and the corresponding hook 92 formed on the second base member 80 may define a path of rotation of the child seat 24 relative to the support base 22. As shown in the FIGS., the child seat 24 is rotatable between a first rotational configuration, such as a configuration in which the child seat 24 is in a facing-forward position (FIG. 2), and a second rotational configuration, such as a configuration in which a child seat 24 is in a rearward-facing position (FIG. 3). However, it should be appreciated that embodiments where the child seat 24 is positionable in one or more additional configurations between the first rotational configuration and a second rotational configuration are also within the scope of the disclosure.

At least one base anchor member 94 may be fixedly connected to the base back portion 74 of the support base 22. In the illustrated, non-limiting embodiment, a base anchor member 94 is affixed to and protrudes from the second base member 80 near a distal end 96 thereof. The base anchor member 94 is connectable to a corresponding seat anchor member 98 of a child seat 24. Such a seat anchor member 98 is typically arranged at a surface of a seat back portion 28 of the child seat 24 (e.g., located behind the child's back), and therefore the base anchor member 94 is connectable thereto when the child seat 24 is in a forward-facing configuration. As will be described in more detail below, the base anchor member 94 may also be connectable to the seat anchor member 98 regardless of the angle of incline of the child seat 24 relative to the support base 22. This connection between the base anchor member 94 and the seat anchor member 98 stabilizes the seat back portion 28 of the child seat 24. In such embodiments, the base anchor member 94 may not be connectable to the seat anchor member 98 when the child seat 24 is in a rearward-facing configuration. However, it should be understood that the base anchor member 94 may be suitable for use with a seat anchor member arranged at any location about a child seat 24.

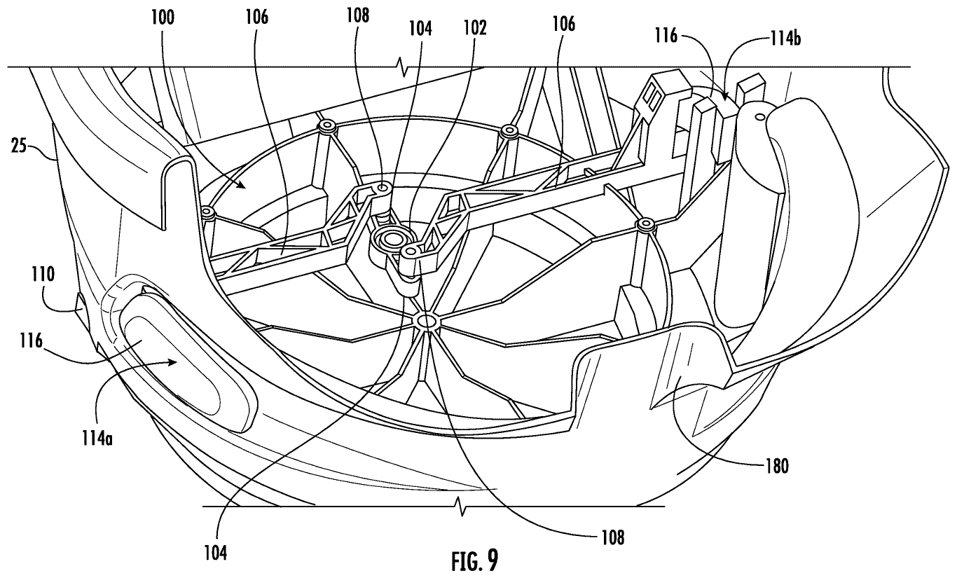

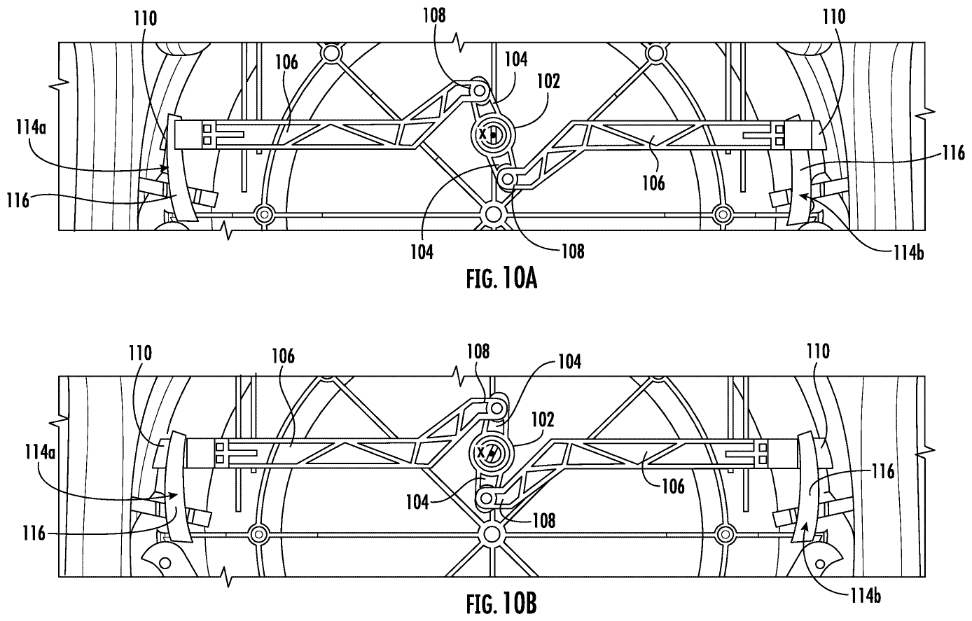

The child restraint system 20 may include a spin lock 100 operable to selectively lock the child seat 24 at one the plurality of configurations relative to the support base 22. In the illustrated, non-limiting embodiment, the spin lock 100 is arranged within the seat shell 25 of the child seat 24, such as within the portion of the end 86 receivable within the support base 22. With reference to the non-limiting embodiment shown in FIGS. 9-10B, the spin lock 100 includes a centrally positioned connecting link 102 that is rotatable about an axis X. As shown, the connecting link 102 may have two end segments 104 extending outwardly therefrom, such as disposed on opposite sides of the connecting link 102 relative to axis of rotation. A plurality of lock pins, such as two lock pins 106 for example, are connected to the connecting link 102. For example, a first end 108 of each lock pin 106 is connected to a respective end segment 104 of the connecting link 102. As shown, the lock pins 106 may extend from the connecting link 102 in opposite directions.

The lock pins 106 are transformable between a first, locked position (FIG. 10A) in which the child seat 24 is not rotatable relative to the support base 22, and a second, unlocked position (FIG. 10B) in which the child seat 24 is freely rotatable relative to the support base 22. When each of the lock pins 106, and therefore the spin lock 100, is in a locked position, a second, opposite end 110 of the lock pin 106 extends through an opening (not shown) formed in the seat shell 25 and is engaged with a corresponding lock section 112 (see FIG. 7), such as a groove or slot for example formed in a portion of the support base. When the lock pins 106, and therefore the spin lock 100, is in the second, unlocked position, the second ends 110 of the lock pins 106 are separated from the lock section 112, allowing the child seat 24 to be rotated relative to the second base member 80. In the illustrated, non-limiting embodiment, the plurality of lock sections 112 are formed in the second base member 80. However, embodiments where plurality of the lock sections 112 are formed in the first base member 76 are also contemplated herein.

In an embodiment, a biasing member (not shown), such as a torsion spring for example, is operably coupled to the connecting link 102 to bias the connecting link 102, and therefore the lock pins 106, to the first locked position. At least one actuator 114 is operably coupled to at least one of lock pins 106. In the illustrated, non-limiting embodiment, a plurality of actuators 114 are operably coupled to the spin lock 100. As shown, a first actuator 114a is operably coupled to the first lock pin 106 and a second actuator 114b is operably coupled to the second lock pin 106. Each actuator 114a, 114b may be independently or individually operable to transform the lock pins 106 from the locked position to the unlocked position. Alternatively, or in addition, the first and second actuator 114a, 114b may be operated simultaneously to transform the lock pins 106 from the locked position to the unlocked position.

In the illustrated, non-limiting embodiment, the one or more actuators 114a, 114b are substantially identical and include a handle 116 arranged at an exterior surface of the child seat 24. The handle 116 may be directly or indirectly connected to a lock pin 106. To operate the actuator 114a, 114b to move the lock pins 106 to the unlocked position, a user applies a force to the handle 116. Although the handle 116 is illustrated as being pulled or pivoted outwardly when operated, embodiments where the handle 116 is moved in another way, such as pushed or pivoted inwardly for example, are also within the scope of the disclosure. In response to the outward force applied to the handle 116, the actuator 114a applies an opposite force to the first lock pin 106 coupled thereto. The inward movement or translation of the first lock pin 106 causes the connecting link 102 to rotate about its axis X in a first direction, opposing the bias of the biasing member. Because the second lock pin 106 is also coupled to the connecting link 102, rotation of the connecting link 102 via the first lock pin 106 causes a similar inward movement of the second lock pin 106. Via this inward movement, the second end 110 of both lock pins 106 is disengaged from the corresponding lock section 112 of the support base 22. With the actuator 114a operated and the lock pins 106 disengaged from the lock sections 112, a user may then rotate the child seat 24 relative to the support base 22 to a desired rotational configuration.

Once the child seat 24 has reached the desired rotational configuration, the user will release the actuator 114a, 114b. Upon release of the actuator 114a, 114b, the biasing force of the biasing member will cause the connecting link 102 to rotate and the lock pins 106 to translate outwardly through the openings formed in the seat shell 25 and into engagement with the corresponding lock sections 112 associated with the rotational configuration of the child seat 24.

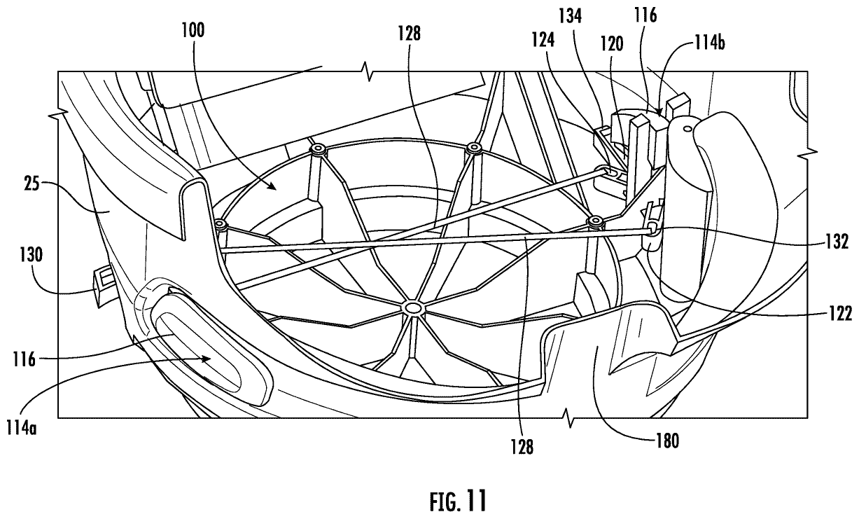

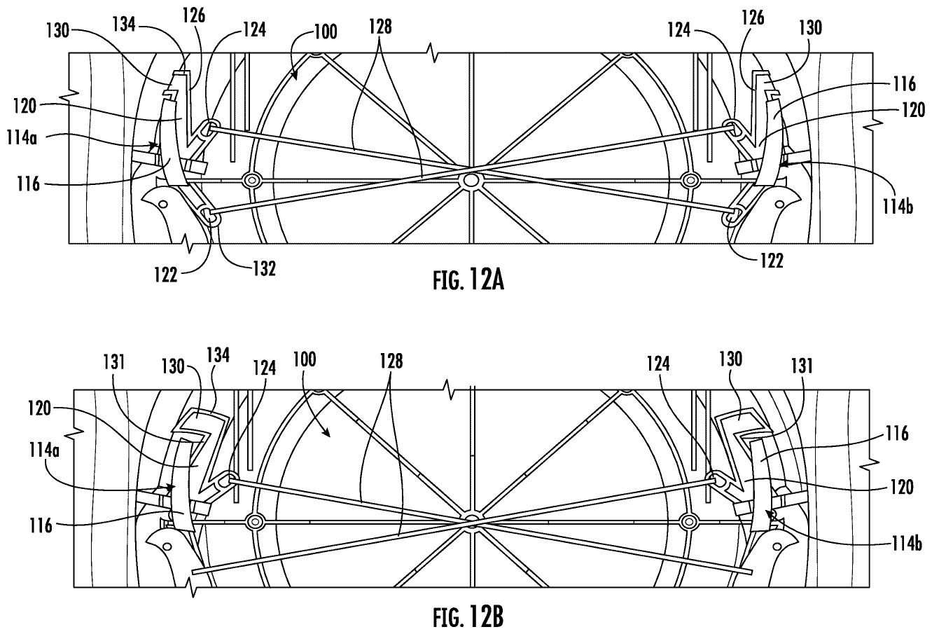

With reference now to FIGS. 11-12B, another example of a spin lock 100 is illustrated. In the illustrated, non-limiting embodiment, the spin lock 100 includes a plurality of lock members, such as a first lock member 120 pivotally mounted near a first side of the seat shell 25 and a second substantially identical lock member 120 pivotally mounted near a second, opposite side of the seat shell 25. Each lock member 120 has a first connector 122 and a second connector 124 extending from a first, inward facing side 126 of the lock member 120 in different directions. A first linking strap 128 extends between and connects the first connector 122 of the first lock member 120 with the second connector 124 of the second lock member 120. Similarly, a second linking strap 128 extends between and couples the second connector 124 of the first lock member 120 with the first connector 122 of the second lock member 120.

The lock members 120 are transformable between a first, locked position (FIG. 12A) in which the child seat 24 is not rotatable relative to the support base 22, and a second, unlocked position (FIG. 12B) in which the child seat 24 is freely rotatable relative to the support base 22. When each of the lock members 120 is in a locked position, a lock pin 130 protruding from a second or outwardly facing surface 131 thereof extends through an opening (not shown) formed in the seat shell 25 and is engaged with a corresponding lock section 112, such as a groove or slot for example formed in a portion of the support base 22. As described with respect to the previous embodiment or the spin lock 100, the lock sections 112 may but need not be formed in the second base member 80. When the lock members 120 are in the second, unlocked position, the lock pins 130 are separated from the lock sections 112, allowing the child seat 24 to be rotated.

A biasing member, such as a torsion spring for example, is operably coupled to at least one of or each the lock member 120 to bias each lock member 120 about its axis to the locked position. Similar to the previous embodiments, an actuator 114a, 114b, such as a handle 116 for example, is operably coupled to each lock member 120, respectively. A first actuator 114a may be operably coupled to the first lock member 120 and a second actuator 114b may be operably coupled to the second lock member 120. Further, each actuator 114a, 114b may be independently operable, or alternatively or in addition, the actuators 114a, 114b may be operable in unison to transform the lock pins 130 from the locked position to the unlocked position.

To unlock the child seat 24, a user applies a force, such as an outward force to the handle 116 of an actuator 114a, 114b. However, it should be appreciated that the spin lock 100 may be adapted for another type of movement of the actuator 114. The first lock member 120 is configured to rotate about its axis in response to operation of the first actuator 114a. This rotation causes the lock pin 130 to rotate inwardly, away from the lock section 112, and an opposite portion of the lock member 120 to rotate outwardly. The connection between the first and second lock members 120 via the plurality of linking straps 128 applies a similar rotational force to the second lock member 120. In the illustrated, non-limiting embodiment, the first connector 122 is positioned near a first end 132 of the lock member 120, and the second connector 124 is positioned near a second end 134 of the lock member 120 and the lock pin 130. Accordingly, when the actuator 114a is operated, the first connector 122 is rotated outwardly, thereby applying a force to the second connector 124 of the second lock member 120 via the first linking strap 128. This force acting on the second connector 124 of the second lock member 120 causes the second lock member 120 to pivot about its axis, thereby disengaging the lock pin 130 from a corresponding lock section 112. With the actuator 114a operated and the lock pins 130 disengaged from the lock sections 112, a user may then rotate the child seat 24 relative to the support base to a desired rotational configuration.

Once the child seat 24 has reached the desired rotational configuration, the user will release the actuator 114a. Upon release of the actuator 114a, the biasing force of the biasing member will cause the first lock member 120 to pivot about its axis to the locked position. In response to this rotation, the second connector 124 of the first lock member 120 will transmit a force to the first connector 122 of the second lock member 120. This force pulls the first end 132 of the second lock member 120 inwardly, causing the lock pin 130 of the second lock member 120 to rotate outwardly and into engagement with an adjacent lock section 112 associated with that position of the child seat 24. It should be appreciated that the various configurations of the spin lock 100 illustrated and described herein are intended as an example only and that any mechanism suitable to selectively lock and unlock the child seat 24 with respect to rotation about an axis relative to the support base 22 is within the scope of the disclosure.

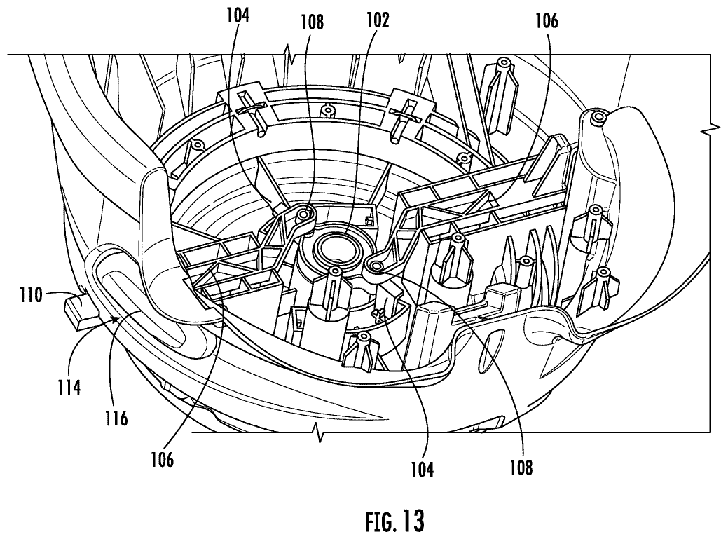

With reference now to FIGS. 13-15B, an alternative embodiment of the spin lock 100 is illustrated. In the non-limiting embodiment, the spin lock 100 is substantially identical to the spin lock illustrated and described with respect to FIGS. 9-10B; however, unlike the embodiment shown in FIGS. 9-10B, the rotational axis X of the connecting link 102 is coaxial with the rotational axis of the child seat 24 relative to the support base 22. It should be appreciated that embodiments where these axes are offset from one another, such as shown in FIGS. 9-10B are also within the scope of the disclosure.

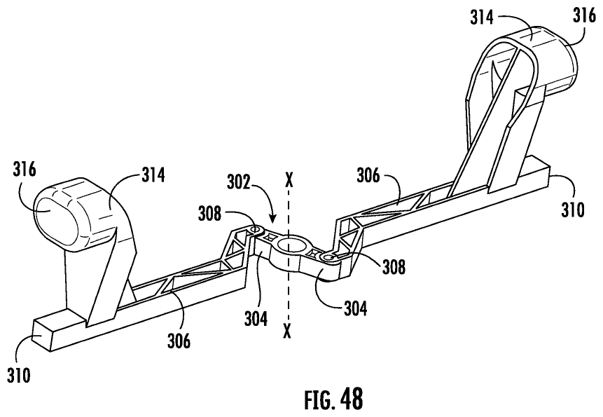

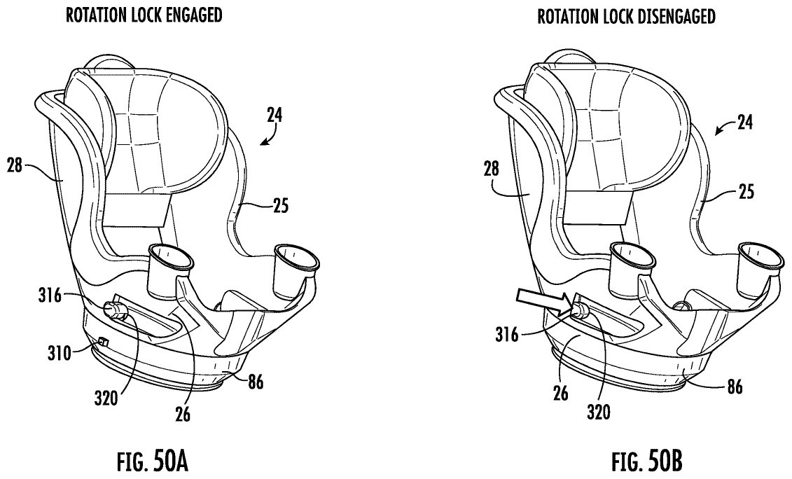

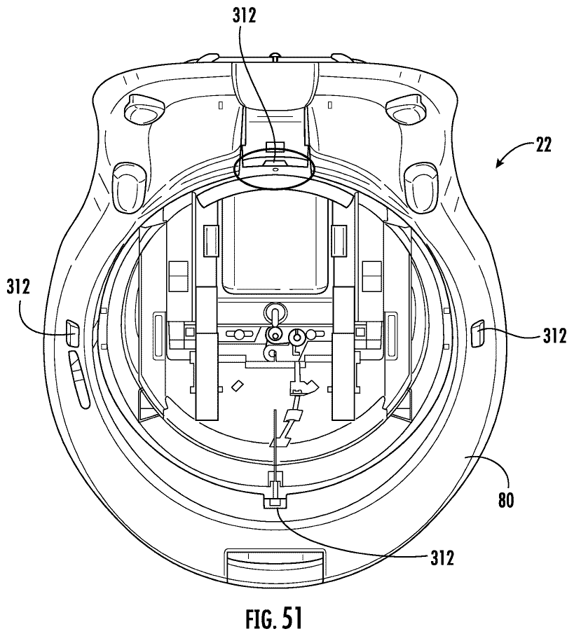

Another example of a spin lock 300 is illustrated in FIGS. 48-51. Similar to the previous embodiments, the spin lock 300 is arranged within the seat shell 25 of the child seat 24, such as within the portion of the end 86 receivable within the support base 22. As shown, the spin lock 300 includes a centrally positioned connecting link 302 that is rotatable or pivotable about an axis X. The connecting link 302 may be affixed to the support base 22 via any suitable connection mechanism, such as a pin or bolt for example, which allows the connecting link 302 to freely spin about its axis. As shown, the connecting link 302 may have two end segments 304 extending outwardly therefrom, such as disposed on opposite sides of the connecting link 302 relative to axis of rotation. At least one lock pin, such as two lock pins 306 for example, are connected to the connecting link 302. For example, a first end 308 of each lock pin 306 is connected to a respective end segment 304 of the connecting link 302. As shown, the lock pins 306 may extend from the connecting link 302 in opposite directions. Although the spin lock 300 is illustrated and described as having two lock pins, embodiments where the connecting link 302 includes a single end segment 304 and/or only a single lock member 306 is operably coupled to the connecting link 302 are also within the scope of the disclosure.

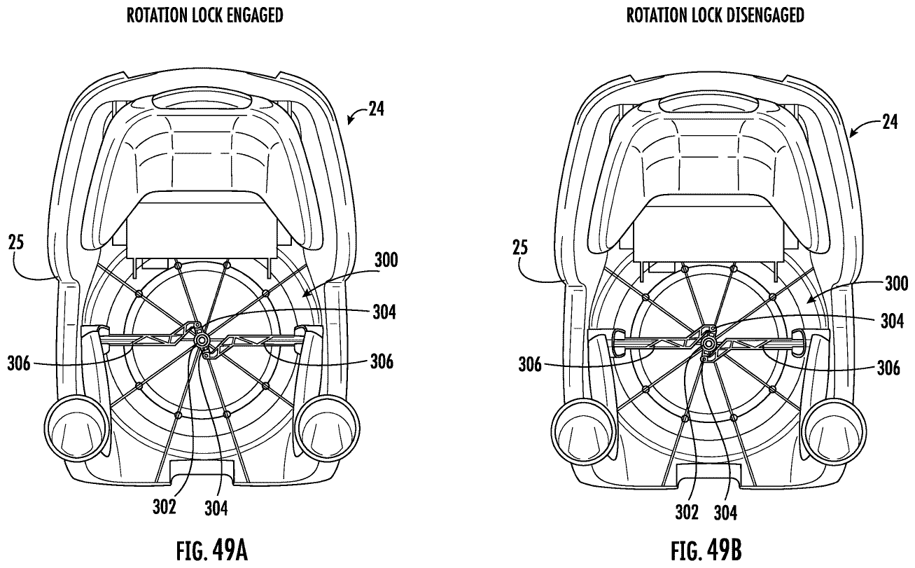

Similar to the previously described embodiments, the lock pins 306 are transformable between a first, locked position (FIG. 49A) in which the child seat 24 is not rotatable relative to the support base 22, and a second, unlocked position (FIG. 49B) in which the child seat 24 is freely rotatable relative to the support base 22. When each of the lock pins 306, and therefore the spin lock 300, is in a locked position, a second, opposite end 310 of the lock pin 306, such as a boss arranged at the second end of the lock pin 306 for example, extends through an opening (not shown) formed in the seat shell 25 and is engaged with a corresponding lock opening 312 (see FIG. 51), such as a groove or slot for example formed in a portion of the support base. When the lock pins 306, and therefore the spin lock 300, is in the second, unlocked position, the second ends or bosses 310 of the lock pins 306 are separated from the lock opening 312, allowing the child seat 24 to be rotated relative to the second base member 80. In the illustrated, non-limiting embodiment, the plurality of lock openings 312 are formed in the second base member 80. However, embodiments where plurality of the lock openings 312 are formed in the first base member 76 are also contemplated herein. Although not shown, a biasing member (not shown), such as a torsion spring for example, may be operably coupled to the connecting link 302 to bias the connecting link 302, and therefore the lock pins 306, to the first, locked position.

An actuator 314 is associated with at least one of the lock pins 306. In the illustrated, non-limiting embodiment of FIGS. 48-51, the spin lock 300 includes a respective actuator 314 operably coupled to each of the lock pins 306. As shown, the actuator 314 may be integrally formed with a lock member 306 such that the actuator 314 and lock pin 306 are a single unitary body. The actuator 314 may be arranged near the second end 310 of the lock pin 306 and may extend at an angle relative thereto. Although the actuator 314 is illustrated as being arranged vertically above the lock pin 306, embodiments where the actuator 314 is at another position relative to the lock pin 306, such as at a side of the lock pin 306 for example, are also contemplated herein. An outward facing surface 316 of the actuator 314 may be vertically aligned with the second end 310 of the lock pin 306. In other embodiments, the outward facing surface 316 may be spaced further from the axis of the connecting link 302 than the second end 310. The actuator 314 is arranged within, and in some embodiments, extends through, an opening 320 formed in the seat base 26. The actuator and the lock pin 306 may be movable in the same direction, such as an actuation direction for example, to selectively disengage the boss 310 from a respective lock opening 312.

When a force is applied to an actuator 314, such as in a direction toward an interior of the child seat 24 for example, the actuator 314 and the lock pin 306 together translate laterally toward the axis. This translation causes the boss 310 of the lock pin 306 to disengage from a corresponding lock opening 312 formed in the support base 22 and causes the connecting member 302 to rotate about its axis. Because the lock members 306 are symmetrically attached to the connecting member 302, actuation of one lock pin 306 results in tandem movement of the plurality of lock members 306. Once the lo lock pins 306 are separated from the support base 22, the user may spin or rotate the child seat 24 relative to the support base 22. Once the child seat 24 is in a desired rotational position, the force applied to the actuator 314 is released. In response to removal of the force, a biasing mechanism (not shown) operably coupled to the connecting member 302 biases the connecting member 302 about its axis and the lock pins 306 into an engaged position to relock the child seat 24 to the support base 22. Thie biasing force of the biasing mechanism prevents the child seat 24 from being rotated when an actuator 314 of the spin lock 300 is not depressed.

However, it should be understood that embodiments where an actuator 314 is arranged at another position about the child seat 24, such as near a front of the child seat 24 for example, are also within the scope of the disclosure. In such embodiments, the actuator may be directly or indirectly coupled to the lock pin 306. In embodiments where the actuator 314 is arranged near a front of the child seat, such as near an occupant's feet, the position of the actuator 314 and/or the biasing force of the biasing mechanism associated with the connecting member 302 may be sufficient to prevent accidental unlocking of the spin lock 300 if the actuator 314 is kicked by the occupant.

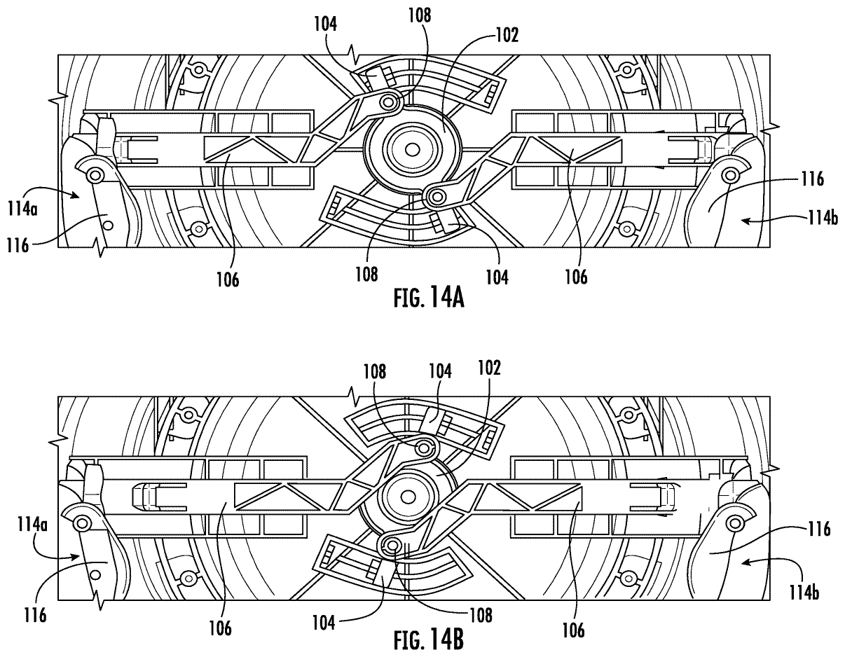

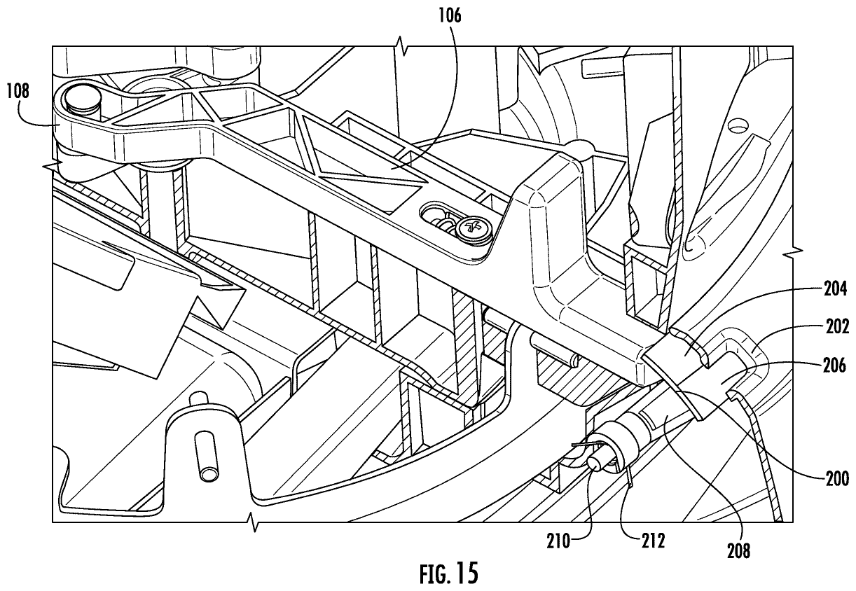

With reference to FIGS. 15-17B, in an embodiment, the spin lock 100 may additionally provide a visual indicator 200 to an operator of the child restraint system 20 to indicate whether the lock members, such as members 106 or 120 for example, are engaged with the support base 22 such that the child seat 24 is locked against rotation relative to the support base 22, or whether the lock members 106, 120, are disengaged from the support base 22, thereby allowing rotation of the child seat 24. The visual indicator 200 is associated with the spin lock 100. In an embodiment, the visual indicator 200 is operably coupled to a portion of the spin lock 100, such as a lock member 106 for example, and is arranged in general alignment with a window 202 formed in a portion of the support base 22. A portion of a lock member 106 may be configured to contact and apply a force to the visual indicator 200, for example as the lock member 106 moves from an engaged or locked position to a disengaged or unlocked position. However, embodiments where the visual indicator 200 is movably coupled to or is integrally formed with a portion of the lock member 106 are also within the scope of the disclosure.

In the illustrated, non-limiting embodiment, the indicator 200 includes a first indicator section 204, such as having a first color, that is operable to indicate that the child seat 24 is rotatably locked to the support base 22, and a second indicator section 206, such as having a different color, operable to indicate that the child seat 24 is free to rotate relative to the support base 22. Alternatively, or in addition, the indicator 200 may include alphanumeric characters, such as the words locked or unlocked, or some other symbol to represent one or both of these conditions, respectively.

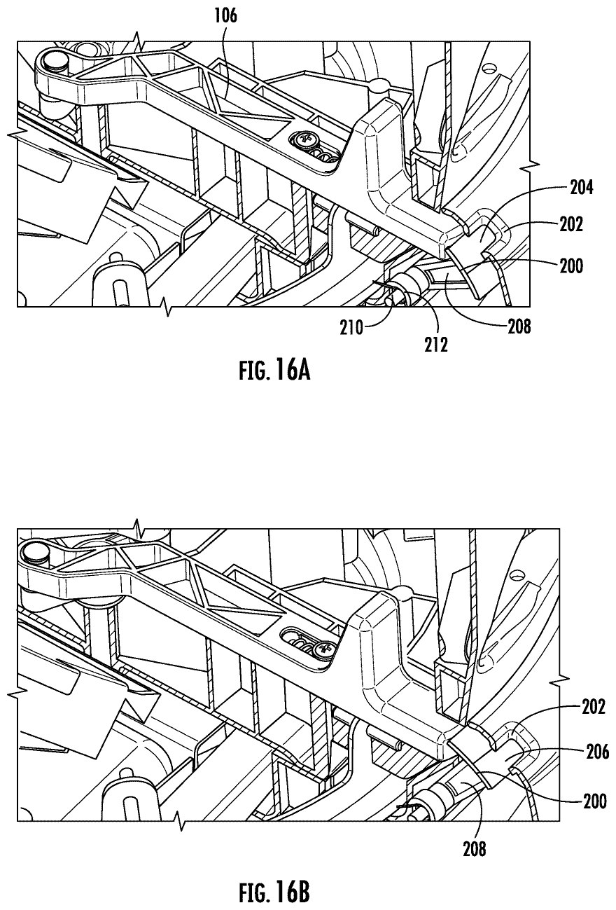

As shown, the indicator 200 may be movably mounted to a wiper 208 that is aligned with a lock member 106. In the illustrated, non-limiting embodiment, the wiper 208 is rotatably mounted to the support base 22 via a pin 210. A biasing member 212, such as a torsion spring for example, is operably coupled to the wiper 208 and a biasing force of the biasing member 212 may bias the indicator 200 to the second position, where the second indicator section 206 is aligned with the window 202 (FIG. 16A). As best shown in the FIGS., a portion of the lock member 106 is operable to engage at least one of the wiper 208 and the indicator 200 when the lock member 106 is in the locked position. The force applied to the wiper 208 or indicator 200 by the lock member 106 opposes the biasing force of the biasing member 212, thereby retaining the indicator 200 in a position where the first indicator section 204 is aligned with the window 202.

When a user applies a force to a handle 116 of the actuator 114 to release the spin lock 100, the lock member 106 is moved, for example translated, out of engagement with the indicator 200 and/or wiper 208. As a result, the biasing force of the biasing member 212 will bias the wiper 208 and indicator 200 to a position where the second indicator section 206 of the indicator 200 is aligned with the window 202 (FIG. 16B). Once the force is released from the handle 116, the biasing member associated with the spin lock 100 will bias the lock members 106 toward the locked position, and into engagement with the indicator 200 and/or wiper 208 as previously described.

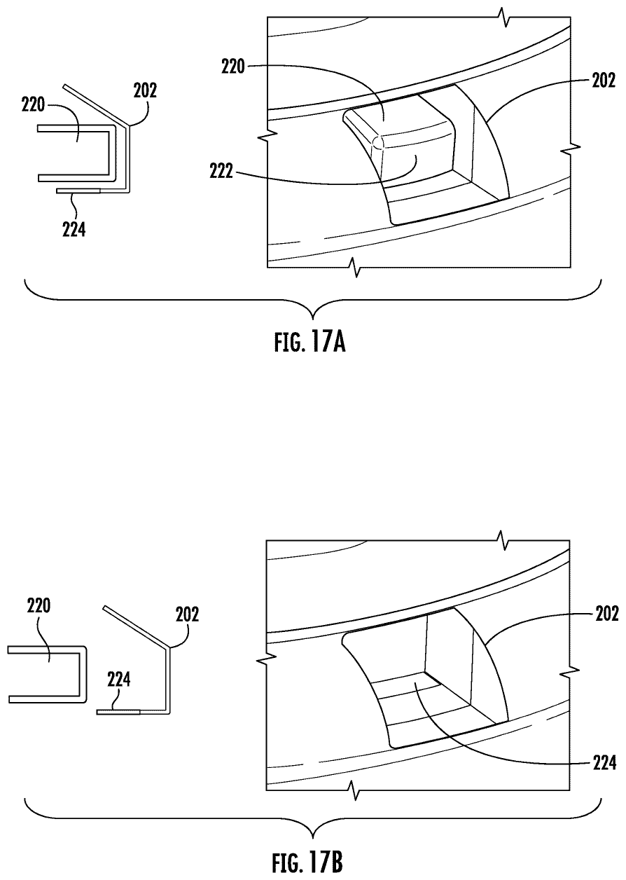

With reference now to FIGS. 17A-17B, an indicator according to another embodiment of the child restraint system 20 is illustrated. As shown, the support base 22 includes a window 202 associated with the indicator 200. When the child seat 24 is rotatably locked to the support base 22, a plunger 220 extends through the window 202 (FIG. 17A). The plunger 220 may be part of a lock member 106 or may be a separate component movably coupled thereto. The portion of the plunger 220 visible at the window 202 may have a first color or alphanumeric marking or symbol 222 to indicate that the spin lock 100 is engaged. When the spin lock 100 is locked, the plunger 220 may overlap with the second indicator 224, thereby preventing the second indicator from being visible via the window 202. When the handle 116 of an actuator 114 is operated, and the lock members 106 of the spin lock 100 are in the unlocked position, the plunger 220 may be moved, for example retracted, and therefor is not present within the window 202. Rather, as shown in FIG. 17B, in absence of the plunger 220, the visible portion of the support base 22 through the window 202 has a second color or alphanumeric marking or symbol 224, and therefore functions as a second indicator 224 to indicate that the spin lock 100 is disengaged and the child seat 24 is freely rotatable.

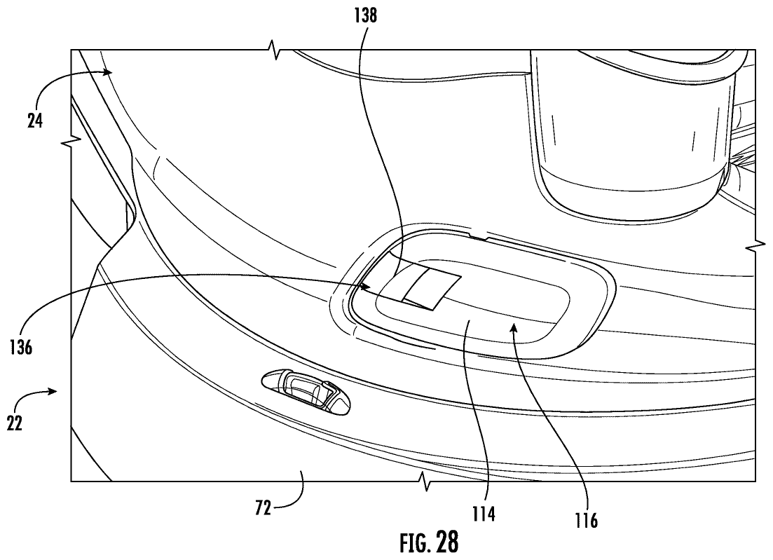

With reference to FIG. 28, in an embodiment, the handle 116 of an actuator 114, such as associated with the spin lock 100 for example, includes a secondary lock 136 operably coupled thereto. In the illustrated, non-limiting embodiment, the secondary lock 136 includes a member 138 movable to selectively disengage the support base 22. For example, the member 138 may include a protrusion receivable within a corresponding groove or recess formed in the support base 22. As shown, the secondary lock 136 may be mounted to the handle 116 to prevent unintentional actuation thereof, and therefore the spin lock 100 to release. In such embodiments, a user must first unlock the secondary lock 136, such as by sliding the member 138 away or out of engagement with the support base 22 for example, before then operating the actuator 114 by applying a force to the handle 116. A biasing mechanism, not shown, may be coupled to the secondary lock to bias the secondary lock into engagement with the support base 22, thereby locking the actuator 114.

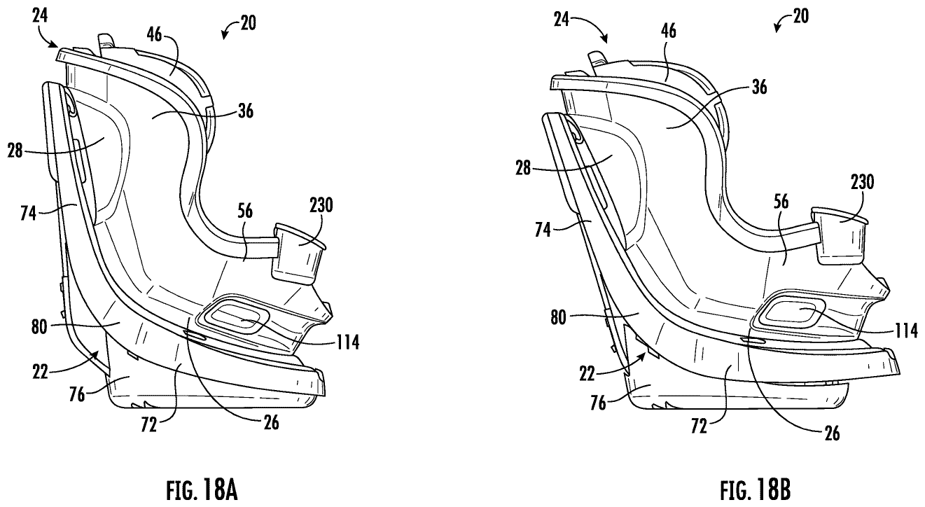

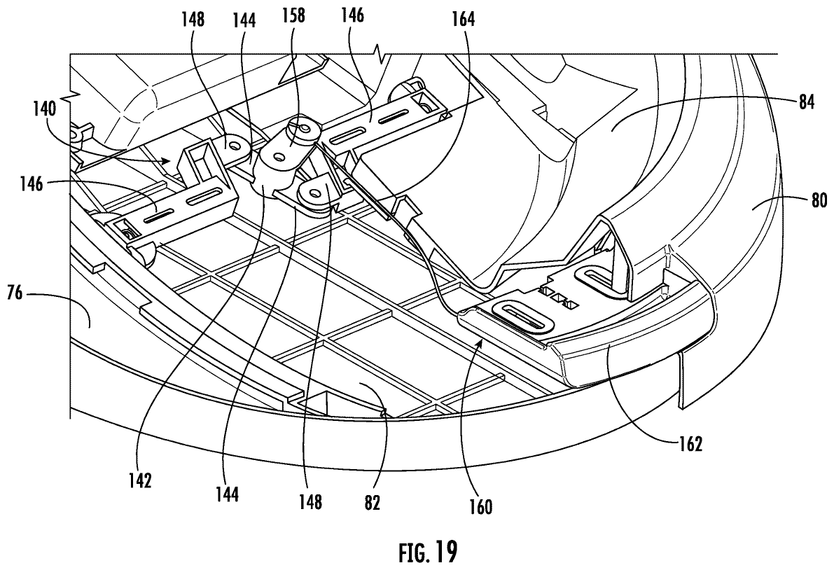

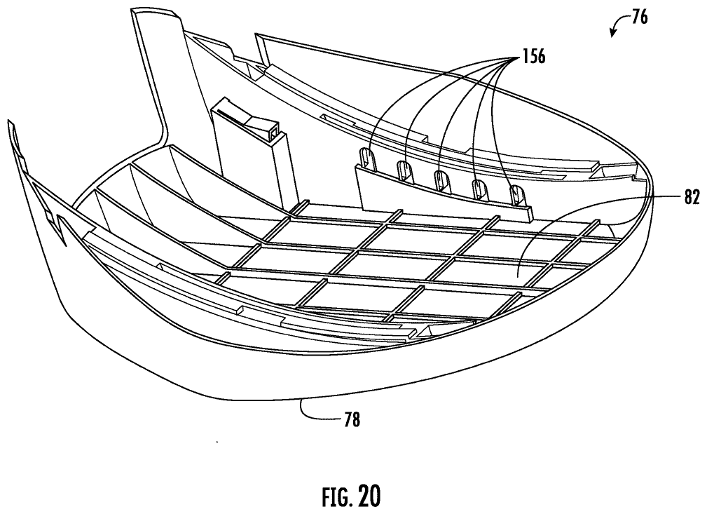

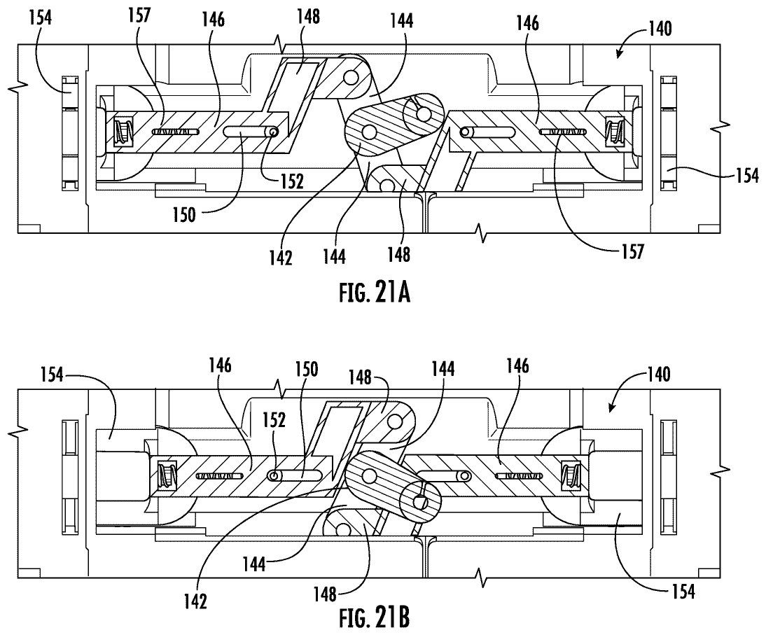

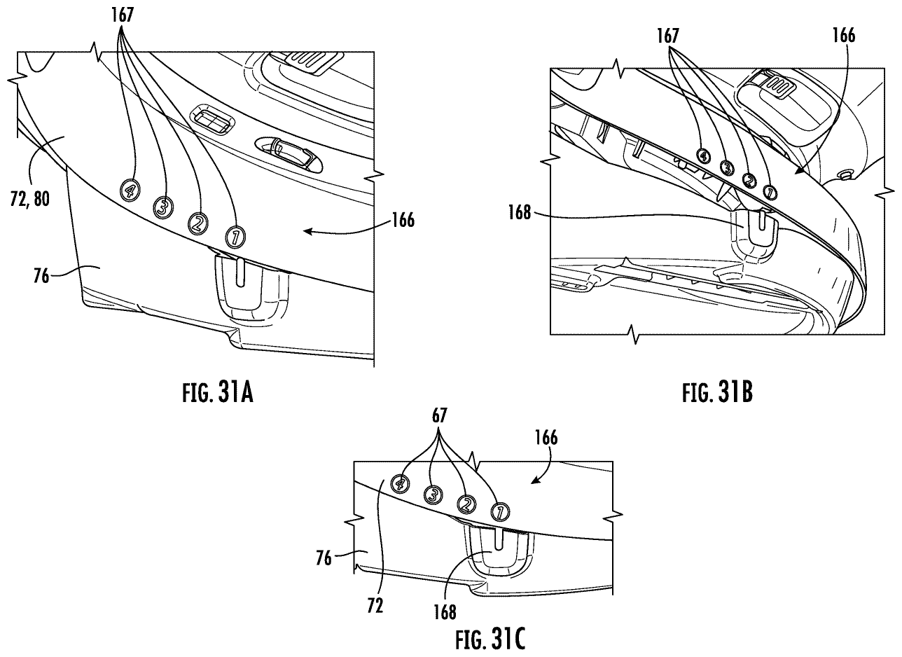

With reference now to FIGS. 18-21B, the child seat 24 may alternatively or additionally be movable relative to the support base 22 to adjust an incline of the child seat 24. The child seat 24 may be movable along an incline path between a first position, such as an upright position (FIG. 21A), and a second position, such as a reclined position (FIG. 21B). However, it should be appreciated that the first position and the second position may both be positions arranged at an incline, the positions having varying degrees of incline. Further, embodiments where the child seat 24 may be arranged in any of a plurality of positions between the upright position and the reclined position are also contemplated herein (see, e.g., FIGS. 31A-C as discussed below).

In an embodiment, the second base member 80, and the child seat 24 coupled thereto, is translatable relative to the first base member 76 to control an incline or recline of the child seat 24. As shown, a recline lock mechanism 140 may be mounted to the second base member 80. In the illustrated, non-limiting embodiment, the recline lock mechanism 140 includes a centrally positioned pivot link 142 that is rotatable about an axis. As shown, the pivot link 142 may have two end segments 144 extending outwardly therefrom, such as disposed on opposite sides of the pivot link 142 relative its axis of rotation. At least one recline pin, such as two recline pins 146 for example, are connected to the pivot link 142 via a respective connector 148. In the illustrated, non-limiting embodiment, the connectors 148 are pivotally coupled to the pivot link 142 and are translatable relative to the recline pins 146. For example, the recline pin 146 may have an elongated slot 150 formed therein and the connector 148 may have a pin or post 152 arranged within the slot 150. As shown, the connectors 148 and recline pins 146 may extend from the pivot link 142 in opposite directions.

The plurality of recline pins 146 are transformable in unison between a first, locked position (FIG. 21A) in which the second base member 80 is not movable relative to the first base member 76, and a second, unlocked position (FIG. 21B) in which the second base member 80, and therefore the child seat 24 rotatably coupled to the second base member 80, is freely movable relative to the first base member 76 to adjust an incline of the second base member 80 and the child seat 24. When each of the recline pins 146 is in a locked position, a second end 154 of the recline pins 146 extends through an opening formed in the second base member 80 and is engaged with a corresponding lock opening 156, formed in a portion of the first base member 76, such as a sidewall thereof for example. When the recline pins 146 are in the second, unlocked position, the second ends 154 of the recline pins 146 are separated or disengaged from the lock openings 156, allowing the second base member 80 and the child seat 24 to be inclined or reclined.

In an embodiment, a biasing member 157, such as a coil spring for example, is operably coupled to each of the recline pins 146 and the connectors 148 and is operable to bias the recline pins 146 to the first, locked position via movement of the connectors 148. In other embodiments, a biasing member may be operably coupled to the pivot link 142. An actuator 160 is operably coupled to the recline lock mechanism 140. In the illustrated, non-limiting embodiment, the pivot link 142 includes a radially extending actuation tab 158 and the actuator 160 includes a handle 162 arranged at an exterior surface of the support base 22. The handle 162 is coupled to the actuation tab 158 via a linkage or cable 164. Application of a force to the handle 162 is operable to rotate the pivot link 142 about its axis. This rotation will apply a force to the recline pins 146, causing the pin 152 of the connector 148 to translate within the slot 150 formed in the recline pin 146. In response to this movement of the pin 152, a force is applied to the biasing member 157 opposing the bias thereof. The movement of the connectors 148 will result in a corresponding movement of the recline pins 146 from the locked position to the unlocked position. While the recline pins 146 are held in the unlocked position via application of a force to the handle 162, the second base member 80 is translatable relative to the first base member 76. As best shown in FIG. 20, the first base member 76 includes a plurality of lock openings 156, each associated with a different incline of the child seat 24. The second base member 80 is therefore movable to a position in which the ends 154 of the recline pins 146 are aligned with and configured to engage respective lock openings of the plurality of lock openings 156. It should be appreciated that the recline lock mechanism 140 illustrated and described herein is intended as an example only and that any mechanism suitable to selectively lock and unlock the child seat 24 and/or second base member 80 with respect to movement relative to the first base member 76 to adjust an incline of the child seat 24 is within the scope of the disclosure.

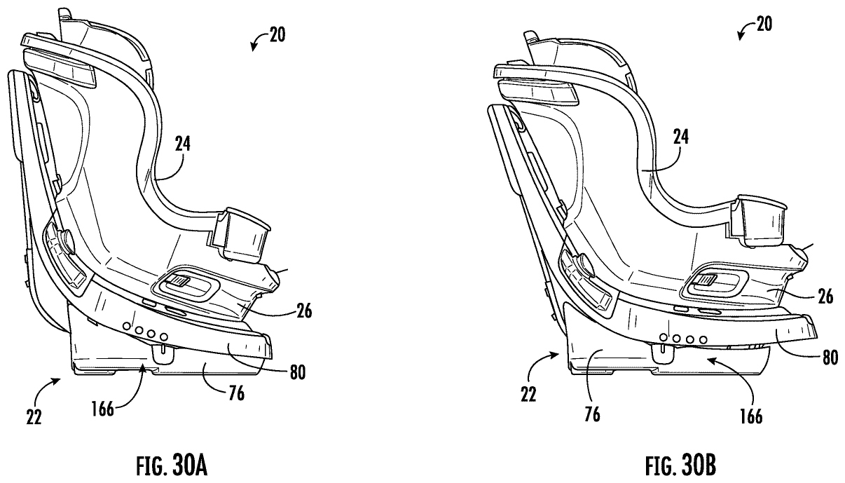

Referring to FIGS. 30A-31C, a recline indicator 166 may be provided to indicate the current recline position of the child seat 24. In the illustrated, non-limiting embodiment, the recline indicator 166 includes a plurality of first markings 167 and a second marking 168. Each of the plurality of first markings 167 is selectively positionable relative to the second marking 168 to represent a corresponding recline position of the child seat 24. The plurality of first markings 167 are spaced apart from one another such that each first marking 167 may be aligned with the second marking 168 in a particular reclined position, due to the translational movement of the second base member 80 relative to the first base member 76. It will be appreciated that four discrete recline positions are shown but various other amounts of discrete positions may be provided. In some embodiments, a continuous range of positions may be indicated. As shown, the base seat portion 72 of the support base 22 includes the plurality of first markings 167 and the first base member 76 includes the second marking 168. However, it should be understood that embodiments where a single first marking 167 is arranged at the base seat portion 72 and the first base member 76 includes a plurality of second markings 168 are also within the scope of the disclosure.

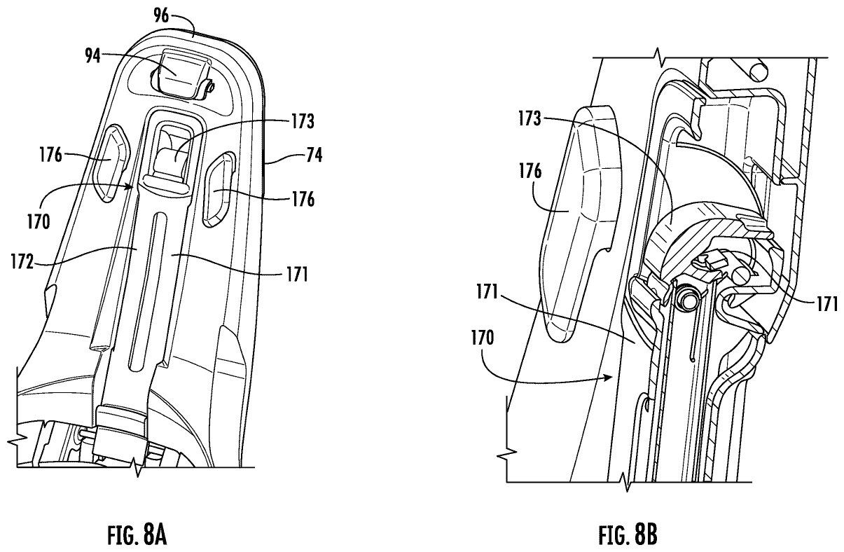

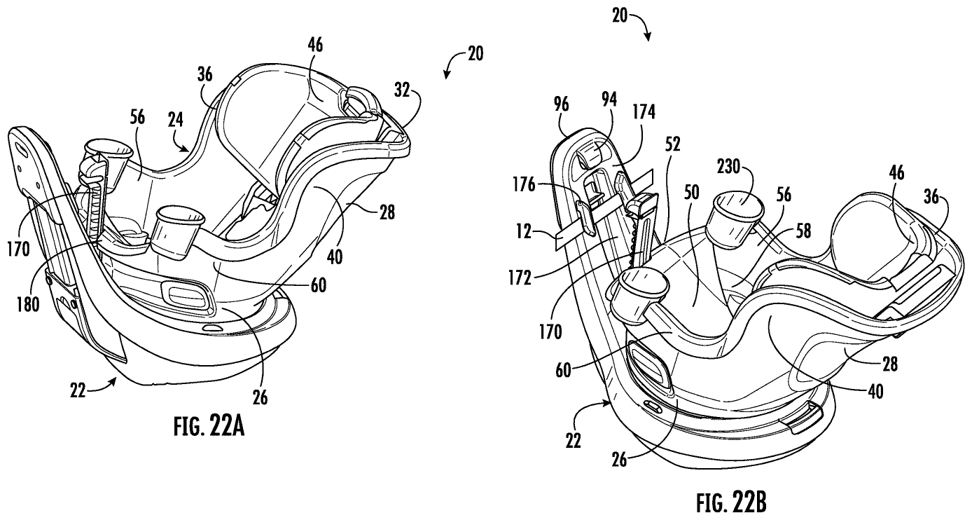

Referring now to FIGS. 7, 8A-8B, 22A-23B, 35, and 36A-B in an embodiment, the support base 22 includes a belt tensioner 170. In the illustrated, non-limiting embodiment, an opening 172 is formed in the base back portion 74 of the support base 22 and the belt tensioner 170 is receivable within the opening 172. A contour of the belt tensioner 170 may be complementary to that of the opening 172 such that the substantial entirety of the belt tensioner 170 is receivable within the opening 172. A vehicle belt 12 (see FIG. 22B) associated with the vehicle seat 10 on which the support base 22 is positionable along a belt receiving path defined between a surface 174 of the base back portion 74 of the support base 22 and the belt tensioner 170. In an embodiment, the belt tensioner 170 includes a frame 171 having an actuator 173 mounted to the frame 171. The actuator 173 may be operable to selectively release or decouple a corresponding engagement member of the frame 171 from a bar or other connector 175 arranged within the opening 172. In the illustrated, non-limiting embodiment shown in FIGS. 8A and 8B, a forward surface or face of the actuator 173 has a generally rounded contour.

In an embodiment, the belt tensioner 170 is selectively movable relative to the support base 22 to adjust the tension applied to the vehicle belt 12 along the vehicle belt receiving path. For example, the belt tensioner 170 may be configured to pivot about at least one axis between an open position (FIGS. 7, 22A and 22B) and a closed position (FIGS. 2 and 3) to selectively pinch or tension the portion of the vehicle belt 12 sandwiched between the belt tensioner 170 and the opening 172 to couple the support base 22 to the vehicle belt 12, thereby restricting movement of the support base 22 relative to the vehicle seat 10.

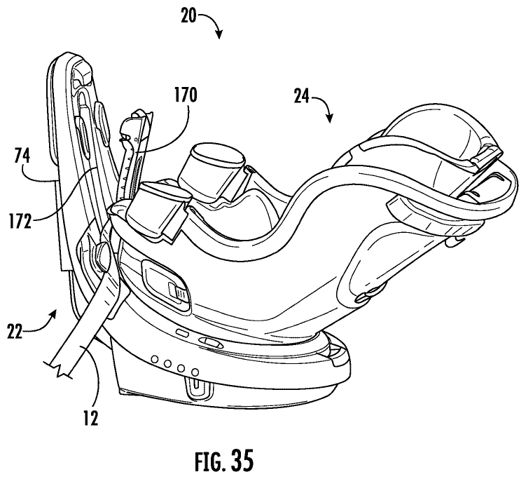

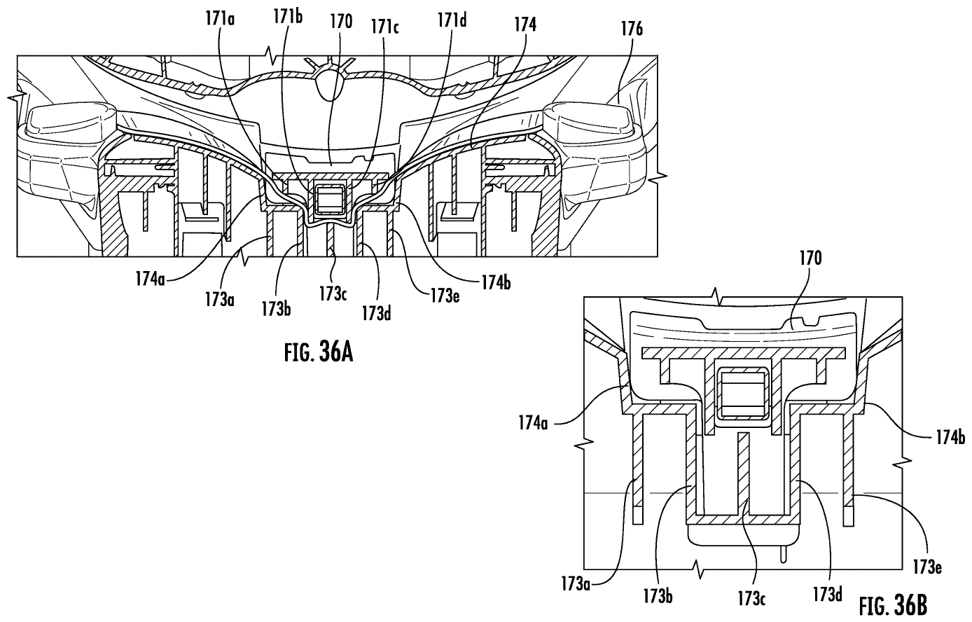

With reference now to FIGS. 35-36B, in some embodiments the vehicle belt 12 may be pressed against or between various features of the belt tensioner 170 and/or the base back portion 74 of the support base 22 to provide additional tension and/or friction, thereby preventing the vehicle belt 12 from sliding relative to the support base 22. In an embodiment, shown in FIGS. 36A-B, the belt tensioner 170 may include one or more tensioner ribs 171a-171d that protrude from the belt tensioner 170 toward and into the opening 172. In embodiments including a plurality of tensioner ribs 171a-171d, the ribs may extend different axial lengths from a surface of the belt tensioner 170. The base back portion 74 may provide one or more features at or within the opening 172. In the illustrated, non-limiting embodiment, the at least one feature includes a plurality of back ribs 173a-e. The back ribs 173a-e may include corner ribs 173b, 173d and/or a center rib 173c. The surface 174 of the base back portion 74 may additionally or alternatively provide one or more features at or proximate the opening 172 such as first and second surface corners 174a, 174b. The first and second corners 174a, 174b may define a variable surface complementary to the different axial lengths of the tensioner ribs 171a-171d. Accordingly, when the belt tensioner 170 is closed and received within the opening 172 as shown in FIG. 36A, the vehicle belt 12 is forced to change direction along a sinuous or convoluted path defined between the tensioner ribs 171a-171d, the first and second corners 174a, 174b, and one or more center back ribs 173a-173e. Further, the vehicle belt 12 is pinched or tensioned at multiple locations along the sinuous path.

In an embodiment, best shown in FIG. 22B, one or more belt guides 176 may be positioned about the support base 22, such as the base back portion 74 thereof. As shown, the belt guide 176 may include a slot 178 for receiving a portion of a vehicle belt 12 therein. Although substantially identical belt guides 176 are illustrated as being arranged at opposite sides of the base back portion 74, it should be appreciated that embodiments having a single belt guide are within the scope of the disclosure. Further, in embodiments including a plurality of belt guides 176, the belt guides may have varying configurations and/or may be arranged at different vertical and lateral positions based on the vehicle belt path relative to the support base 22. In the non-limiting embodiment shown in FIGS. 23A-23B, a belt guide 176 may be mounted to a support base 22, such as to a surface of a base back portion 74 via a belt path insert 177. The belt path insert 177 may be permanently or removably affixed to the support base 22, and the belt guide 176 may be permanently or removably connected to the belt path insert 177. Inclusion of a belt path insert 177 allows the belt guide 176 to be located at a position laterally offset from the base back portion 74.

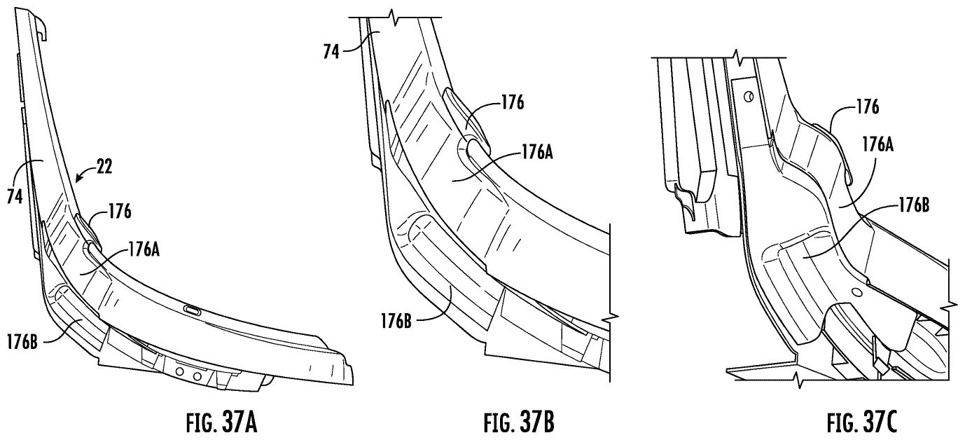

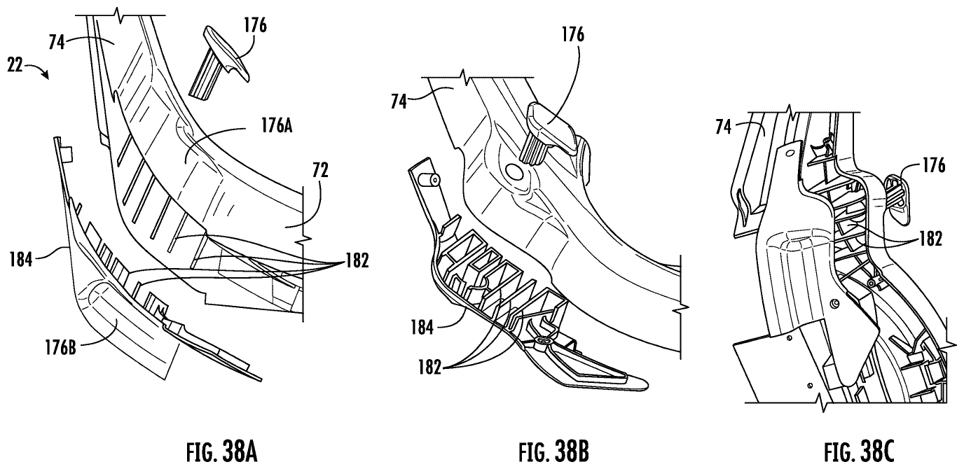

Referring to FIGS. 37A-C and 38A-C, in some embodiments a belt guide 176 may be provided at a lower region of the support base 22, such as proximate to an interface between the base back portion 74 and the base seat portion 72. The belt guide 176 may be arranged to receive a lap belt of a vehicle belt 12. One or more contoured regions 176A, 176B may be provided on surfaces of the base back portion 74, for example contoured region 176A on a side surface and contoured region 176B on side and bottom surfaces. The contoured regions 176A, 176B are arranged to receive the vehicle belt 12 and further guide it about the support base 22. As shown in FIGS. 38A-C, a plurality of ribs 182 may be provided in this region of the support base 22 to provide additional stiffness and strength where the vehicle belt 12 presses against the support base 22. In some embodiments, a bottom cover 184 may be provided and include a portion of the ribs 182 in a complementary arrangement to provide a rigid structure when assembled with the support base 22.

With reference to FIG. 24, in an embodiment, a notch or cutout 180 is formed at the front edge 52 of the child seat 24. To use the belt tensioner 170 to affix the support base 22 to a vehicle seat 10 via the vehicle belt 12, the child seat 24 is rotated relative to the support base 22 to the rearward-facing configuration. In the rearward-facing configuration, the notch is aligned with the belt tensioner 170 and the corresponding opening 172 such that when the belt tensioner is opened, or separated from the opening 172, the belt tensioner 170 is arranged within the notch 180 formed in the child seat 24. Accordingly, when the belt tensioner 170 is positioned within the notch 180, the belt tensioner 170 interferes with and restricts rotation of the child seat 24 relative to the support base 22. Only once the belt tensioner 170 has been closed or received within the opening 172 can the child seat 24 be transformed from the rearward-facing configuration to another configuration.

In an embodiment, the tension applied to the vehicle belt 12 by the belt tensioner 170 is dependent on the position of the second base member 80 relative to the first base member 76, and therefore the incline of the child seat 24. Accordingly, in an embodiment, the child seat 24 may be in a reclined or at least partially reclined position when the vehicle belt 12 is coupled to the support base 22 via the belt tensioner 170. During installation of the support base 22 about a vehicle seat 10, after the belt tensioner 170 has applied an initial tension to the vehicle belt 12, the incline of the child seat 24 is then adjusted to increase the tension of the vehicle belt 12. The recline lock mechanism 140 coupling the second base member 80 to the first base member 76 may be unlocked, and the incline of the child seat 24 may be adjusted, for example increased, while the child seat 24 is in any suitable rotational configuration relative to the support base 22. As the second base member 80 and the child seat 24 translate relative to the first base member 76, the corresponding movement of the belt tensioner 170 increases the tension to the vehicle belt 12.

The first and second seat side members 56, 60 may form an armrest for a child seated within the child seat 24. In some embodiments a cupholder 230 may be located near an end of at least one of the first and second seat side members 56, 60, for example closest to the front 52 of the seat support surface. These cupholders 230 may be fixed, or in some embodiments may be rotatable relative to the seat shell 25 while remaining attached thereto. The rotatable cupholder 230 can 1.) provide a child seated within the child seat 24 with easy access to the cupholder 230, 2.) be moved to a position to allow a child to get into and out of the seat 24 more easily, 3.) be moved to a position to minimize any interference of the cupholder 230 with the seat 24 and support base 22 during rotation of the seat 24, and 4.) be moved to a position to minimize the overall size (e.g. envelope) of the child restraint system 20 for, for example, packaging, shipping, and placement of the system 20.

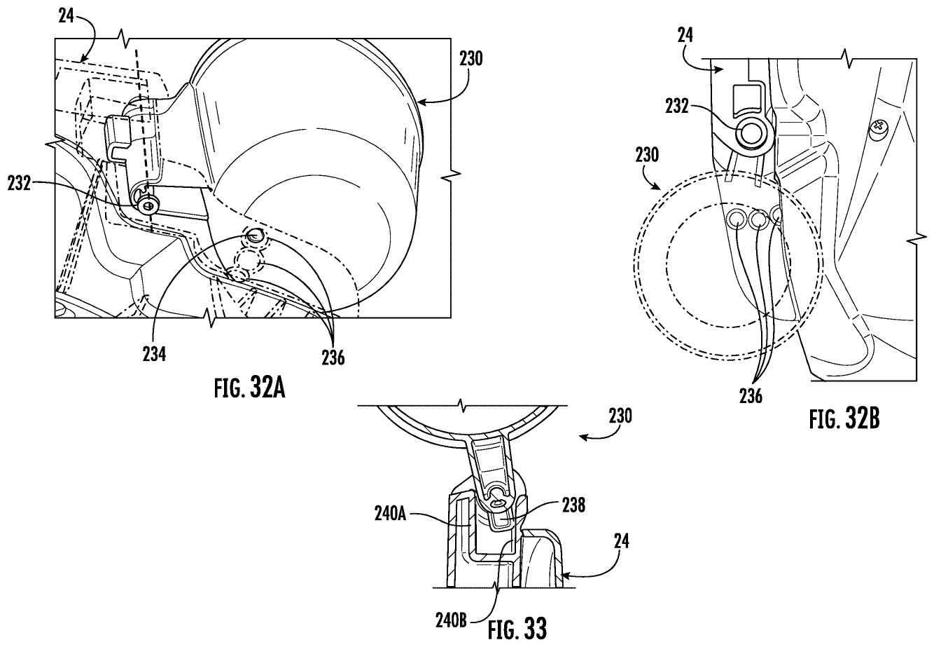

Referring to FIGS. 32A-33, a cupholder 230 is rotatable and is configured to retain discrete positions, for example to prevent accidental movement of the cupholder during transport or use. In the illustrated embodiment, the cupholder 230 rotates about a pivot member 232 mounted with the child seat 24. In an embodiment, the cupholder 230 includes a detent 234, such as arranged at a bottom surface thereof, and the child seat 24 includes a plurality of recesses 236 within which the detent 234 is receivable. The plurality of recesses 236 may be arranged to define a plurality of different positions of the cupholder 230 relative to the child seat 24. Engagement between the detent 234 and a corresponding recess 236 of the plurality of recesses may retain the cupholder 230 in that position. There may be resiliency in one or both of the detent 234 and the material defining the recesses 236, such that the detent 234 may be disengaged from a recess 236 when a sufficient force is applied. Once the detent 234 is separated from the recess 236, the cupholder 230 is free to rotate about its pivot axis. In some embodiments, the pivot member 232 may be removable from the child seat 24 to allow for the cupholder 230 to be removed.

As shown in FIG. 33, rotation of the cupholder 230 may be limited to a desired range. In the illustrated non-limiting embodiment, the cupholder 230 includes a tab 238 on the opposite side of the pivot member 232. The child seat 24 may include a recess defined by sidewalls 240A, 240B. The tab 238 and sidewalls 240A, 240B are sized to allow a desired range of rotation but engagement between the tab 238 and one or more of the sidewalls 240A, 240B prevents any further rotation. Accordingly, the sidewalls 240A, 240B may function as a rotation limit stop.

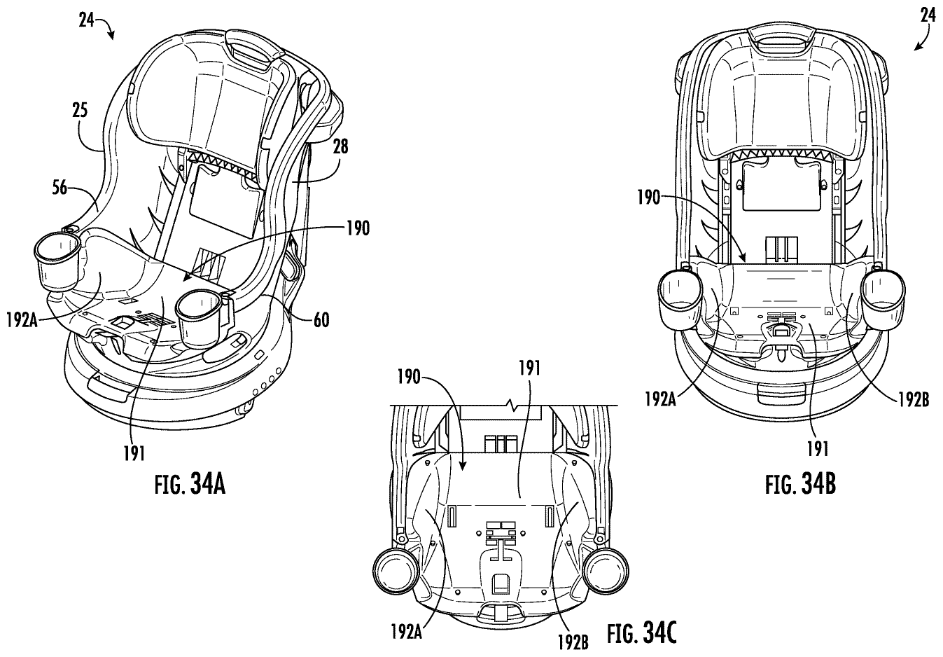

Referring to FIGS. 34A-34C, in some embodiments, the child seat 24 may include a seat pan 190 with a bottom surface 191 in a bottom portion thereof for supporting a child and providing shape for soft goods. The child seat 24 may also include at least one seat bolster 192A, 192B. As shown, the seat bolsters 192A, 192B may extend from the bottom surface 191 of the seat pan 190 upward, proximate to the top of the corresponding first and second seat side members 56, 60. In embodiments, the seat bolsters 192A, 192B terminate below the first and second seat side members 56, 60 of the seat back portion 28 of the seat shell 25. In some embodiments, the seat bolsters 192A, 192B taper in thickness as they extend toward a front of the child seat 24. The seat bolsters 192A, 192B may also taper in thickness as they extend upward from the seat pan 190. The seat bolsters 192A, 192B are shown as being integrally formed with and from the same material as the seat pan 190; however, in other embodiments the seat bolsters 192A, 192B may be separate parts from the seat pan.

The seat bolsters 192A, 192B are arranged inside the first and second seat side members 56, 60 to reduce the seating width of a portion of the child seat 24, thereby improving side impact protection performance in protecting a child occupant. The seat bolsters 192A, 192B of the illustrated embodiment are sized and positioned to reduce the seating width in the general region of one or more of an occupant's hip, leg, and lower back. This position substantially reduces or substantially eliminates sideways movement of the child's body during a side impact event. Other locations or combinations of locations are contemplated for the seat bolsters 192A, 192B, including a bolster on only one side of the seat pan 190. Further, one or both of the seat bolsters 192A, 192B may be removable to accommodate different sizes of child. The child restraint system 20 as described herein allows the rotational configuration and the incline of a child seat 24 to be adjusted relative to the support base 22 and a vehicle seat 10. The seat bolsters 192A, 192B may be formed of various materials, including foam or other materials used elsewhere in the child seat 24. In some embodiments, the seat bolsters 192A, 192B are structural components of the child seat 24. The seat bolsters 192A, 192B may be formed of a generally or substantially rigid material or semi rigid material (e.g., hard plastic or foam materials that may be used in a seat shell or headrest), in contrast with the materials of conventional car seat inserts made of, for example, fabric and soft deformable foam without any inner rigid structure.

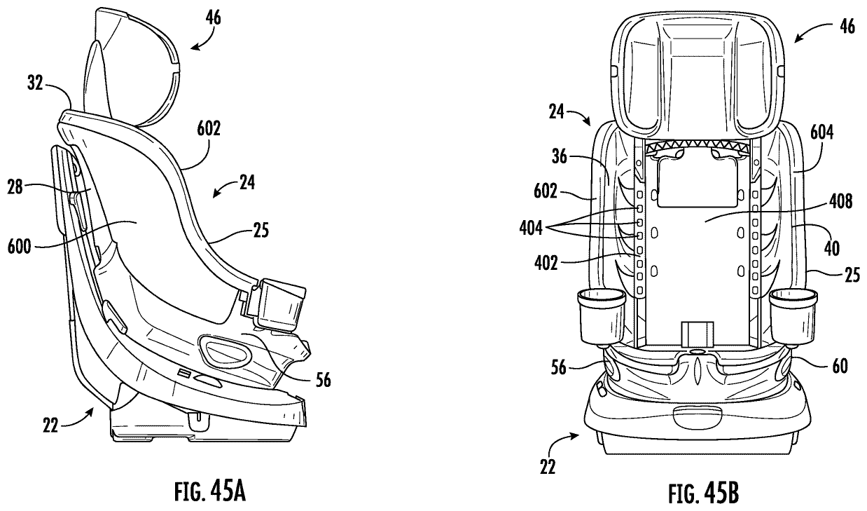

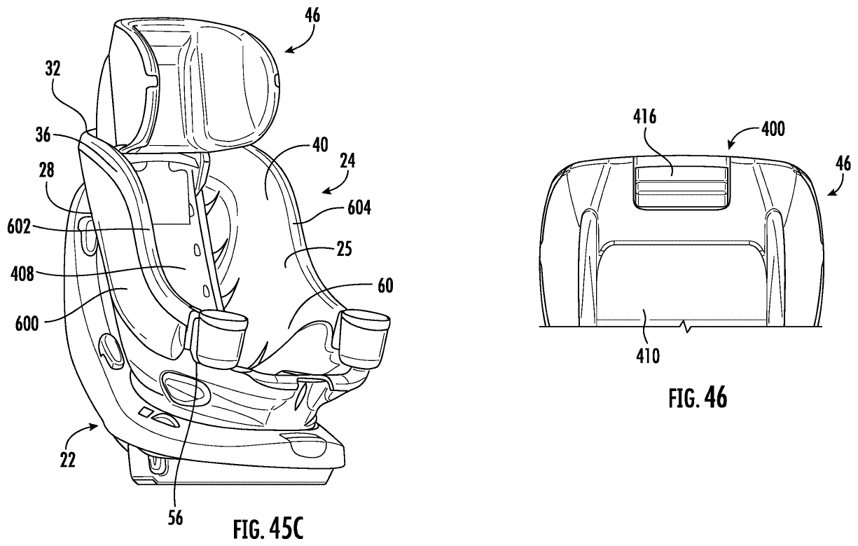

With reference now to FIGS. 45A-45C, as previously described, the child seat 24 includes a back portion 28 including an upright support surface shown at 408, a first upright side member 36 extending from a first side 38 of the upright support surface 408 and a second upright side member 40 extending from a second side 42 of the upright support surface 408. As shown, one or more reinforcement members 600 may be arranged about the child seat 24, such as at the back portion 28 for example. In the illustrated, non-limiting embodiment, the at least one reinforcement member 600 is arranged at an exterior surface of at least one upright side member 36, 40. The reinforcement members 600 may extend from a position near an interface with an adjacent seat side member 56, 60, toward the top 32 of the back portion 28. Further, the reinforcement members 600 may span a substantially entire distance of the side members 36, 40 between the back surface and a forward-facing end 602, 604 of the upright side members 36, 40. Inclusion of such a reinforcement member 600 at the back portion 28 of the seat shell 25 may assist in managing the soft goods (not shown) affixed to the child seat 24. Alternatively, or in addition, the reinforcement members 600 may absorb or redistribute a force applied to the side of the child seat 24, thereby improving the crash performance, including side impact performance, of the child seat 24.

The term “about” is intended to include the degree of error associated with measurement of the particular quantity based upon the equipment available at the time of filing the application. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1.-78. (canceled)

79. A child restraint system positionable on a vehicle seat, the child restraint system comprising:
a support base including a base seat portion and a base back portion; and
a child seat connected to said support base, said child seat including a seat back portion, wherein said child seat with said seat back portion is movable along an incline path relative to said support base between a first position and a second position,
wherein said base back portion is movable with said child seat including said seat back portion along said incline path.

80. The child restraint system of claim 79, wherein said child seat is rotatable relative to said support base at any position of said child seat along said incline path between said first position and said second position.

81. The child restraint system of claim 79, wherein said child seat is rotatable relative to said support base, said child seat being movable along said incline path when said child seat is in both a first rotational configuration and a second rotational configuration.

82. The child restraint system of claim 81, wherein said support base further comprises a base anchor member and said child seat further comprises a seat anchor member, said base anchor member being connectable to said seat anchor member when said child seat is in said first rotational configuration.

83. The child restraint system of claim 82, wherein said base anchor member is connectable to said seat anchor member at any position of said child seat along said incline path between said first position and said second position.

84. The child restraint system of claim 79, further comprising a recline lock mechanism for selectively locking movement of said child seat at a position along said incline path.

85. The child restraint system of claim 84, wherein said support base further comprises:
a first base member; and
a second base member operably coupled to said first base member, said second base member forming said base back portion of said support base.

86. The child restraint system of claim 85, wherein said recline lock mechanism further comprises at least one recline pin and said first base member further comprises a plurality of lock openings, said at least one recline pin being engaged with a lock opening of said plurality of lock openings when said recline lock mechanism is in a locked position and said at least one recline pin being disengaged from said lock opening of said plurality of lock openings when said recline lock mechanism is in an unlocked position.

87. The child restraint system of claim 86, wherein said at least one recline pin further comprises a plurality of recline pins, said plurality of recline pins being operably coupled to one another by a pivot link.

88. The child restraint system of claim 86, further comprising at least one actuator operably coupled to said recline lock mechanism, said at least one actuator being operable to transform said recline lock mechanism between said locked position and said unlocked position.

89. The child restraint system of claim 79, wherein said child seat is rotatable about an axis relative to said support base between a first rotational configuration and a second rotational configuration, the child restraint system further including:
a spin lock for selectively locking rotation of said child seat relative to said support base; and
at least one actuator operably coupled to said spin lock, wherein said at least one actuator is operable to transform said spin lock between a locked position and an unlocked position in response to application of a force away from said child seat.

90. The child restraint system of claim 89, wherein said spin lock further comprises a plurality of lock pins and said support base further comprises a plurality of lock sections, said plurality of lock pins being engaged with said plurality of lock sections when said spin lock is in said locked position and said plurality of lock pins being disengaged from said plurality of lock sections when said spin lock is in said unlocked position.

91. The child restraint system of claim 90, wherein said plurality of lock pins are operably coupled to one another by a connecting link.

92. The child restraint system of claim 90, wherein said at least one actuator further comprises a plurality of actuators, each of said plurality of actuators being operably coupled to a corresponding lock pin of said plurality of lock pins.

93. The child restraint system of claim 92, wherein each actuator is operable individually to disengage said plurality of lock pins from said plurality of lock sections.

94. The child restraint system of claim 92, wherein said plurality of actuators are operable simultaneously to disengage said plurality of lock pins from said plurality of lock sections.

95. The child restraint system of claim 90, wherein said support base further comprises:
a first base member; and
a second base member operably coupled to said first base member, a bottom of said child seat being receivable within said second base member, wherein said plurality of lock sections are formed in said second base member.

96. The child restraint system of claim 95, wherein said second base member further comprises a hook and said bottom of said child seat further comprises a lip, said hook being engaged with said lip to define a path of rotation of said child seat.

97. The child restraint system of claim 96, wherein said lip is formed by a ring attached to said child seat via at least one fastener.

98. The child restraint system of claim 96, wherein said lip is formed by a ring pinned to said child seat.

99. The child restraint system of claim 90, wherein said spin lock further comprises a plurality of lock members, each of said plurality of lock members including one of said plurality of lock pins, said plurality of lock members being operably coupled by a plurality of linking straps.

100. The child restraint system of claim 89, wherein said child seat is rotatable 180 degrees between said first rotational configuration and said second rotational configuration.

101. The child restraint system of claim 100, wherein said first rotational configuration is a forward-facing configuration and said second rotational configuration is a rearward-facing configuration.

102. The child restraint system of claim 89, wherein said at least one actuator is positioned on said child seat to receive a rotational force from a user and said child seat is rotatable between said first rotational configuration and said second rotational configuration in response to application of said rotational force.

103. The child restraint system of claim 89, further comprising a secondary lock operably coupled to said at least one actuator and movable relative to said support base, said at least one actuator being operable to transform said spin lock between said locked position and said unlocked position only when said secondary lock is disengaged from said support base.

104. The child restraint system of claim 89, wherein said child seat is rotatable between a forward-facing configuration and a rear-facing configuration,
wherein said child seat is movable along an incline path relative to said support base between a first position and a second position,
wherein said child seat is movable along said incline path from said first position to said second position while said child seat is in said forward-facing configuration.
